(19) United States
(12) Patent Application Publication
(10) Pub. No.: US 2026/0357004 A1
(43) Pub. Date: Nov. 12, 2026

(54) FOAM ROLLER, DEVELOPING DEVICE, ELECTROPHOTOGRAPHIC IMAGE FORMING APPARATUS, AND PROCESS CARTRIDGE

(71) Applicant: CANON KABUSHIKI KAISHA, Tokyo (JP)

(72) Inventors: Mototeru GOTO, Shizuoka (JP); Yoshitaka SUZUMURA, Shizuoka (JP); Kenji TAKASHIMA, Kanagawa (JP); Seiji TSURU, Shizuoka (JP)

(21) Appl. No.: 19/634,827

(22) Filed: Mar. 31, 2026

(30) Foreign Application Priority Data
Apr. 22, 2025 (JP) 2025-070418

(51) Int. Cl. C08G 18/66; C08G 18/38; C08G 18/48; C08G 18/76; G03G 15/08; G03G 21/18

(52) U.S. Cl. CPC C08G 18/6685; C08G 18/3819; C08G 18/3844; C08G 18/3848; C08G 18/4837; C08G 18/7614; C08G 18/7671; G03G 15/0808; G03G 21/1814; G03G 21/1867; C08G 2110/005; C08G 2110/0058; C08G 2110/0066; C08G 2110/0083

(57) ABSTRACT

A foam roller comprising: a conductive substrate; and a foam layer on the substrate, wherein the foam layer comprises polyurethane comprising a urethane bond and an anion, the polyurethane comprises at least one specific cationic structure, the anion comprises a bis(fluorosulfonyl)imide anion, an apparent density of the foam layer is 0.03 to 0.25 g/cm³, and when a sum of a content of alkali metal and a content of alkaline-earth metal in the foam layer extracted by immersing the foam layer in acetone is defined as A (mol/g), and a sum of a content of the anion in the foam layer extracted by immersing the foam layer in acetone is defined as B (mol/g), A/B is 0.0400 or less:

### BACKGROUND

### Field of the Technology

The present disclosure relates to a foam roller, a developing device, an electrophotographic image forming apparatus, and a process cartridge.

### Description of the Related Art

There are needs for further increasing a process speed of an electrophotographic image forming apparatus, compatibility with various media, achieving durability performance that enables long-term utilization, and compatibility with various environments. For a foam roller used in an electrophotographic image forming apparatus, a foam layer having a small apparent density has been studied for the purpose of toner supply performance and cost reduction.

On the other hand, in a foam roller having a small apparent density, an abutting part thereof that abuts on a developing roller is likely to be depressed after being left for a long period of time, and toner supply performance at the abutting portion may be degraded. As a result, density irregularity may occur depending on a roller cycle at the time of toner supply.

Japanese Patent Laid-open No. 2020-117578 discloses an ion-conductive-type foamed-conductive elastic roller capable of stably exhibiting excellent performance with a small increase in electrical resistance even during a long-term operation in a high-temperature high-humidity environment.

Japanese Patent Laid-open No. 2020-024407 discloses an electrophotographic member which brings about a small increase in resistance value even in a low-temperature environment at a temperature of 0° C., for example, and which contributes to formation of an electrophotographic image with high quality.

An electrophotographic image forming apparatus for which a high process speed and a longer service life are desired is expected to be able to stably form an excellent electrophotographic image.

However, it has been found that the foamed-conductive elastic roller according to Japanese Patent Laid-open No. 2020-117578 and the electrophotographic member according to Japanese Patent Laid-open No. 2020-024407 require longer time to restore depressions generated at abutting portions immediately after stopping for a long period of time when operated in a low-temperature low-humidity environment, in particular, and toner supply performance at the abutting portions where the depressions have been generated may be degraded.

In other words, in a case where the ion conductive-type foam roller is stopped for a long period of time in a low-temperature low-humidity environment, a depression is likely to be generated at the abutting portion that abuts on a toner supply roller, and it takes longer time to restore the depression, thus the toner supply performance may be degraded, and it may become difficult to form an electrophotographic image with high quality.

### SUMMARY

The present disclosure directs to provide a foam roller which contributes to formation of an electrophotographic image with high quality even immediately after stopping for a long period of time in a low-temperature low-humidity environment. Moreover, the present disclosure directs to provide a developing device, an electrophotographic image forming apparatus, and a process cartridge which contribute to formation of an electrophotographic image with high quality even immediately after stopping for a long period of time in a low-temperature low-humidity environment.

According to at least one aspect of the present disclosure, there is provided a foam roller comprising:
a conductive substrate; and a foam layer on the substrate, wherein
the foam layer comprises polyurethane comprising a urethane bond and an anion,
the polyurethane comprises at least one selected from the group consisting of a cationic structure represented by Structural Formula (1) below, a cationic structure represented by Structural Formula (2) below, a cationic structure represented by Structural Formula (3) below, a cationic structure represented by Structural Formula (4) below, a cationic structure represented by Structural Formula (5) below, and a cationic structure represented by Structural Formula (6) below,
the anion comprises a bis(fluorosulfonyl)imide anion,
an apparent density of the foam layer is 0.03 to 0.25 g/cm³, and
when a sum of a content of alkali metal and a content of alkaline-earth metal in the foam layer extracted by immersing the foam layer in acetone is defined as A (mol/g), and a sum of a content of the anion in the foam layer extracted by immersing the foam layer in acetone is defined as B (mol/g), A/B is 0.0400 or less:

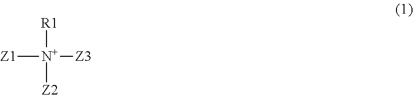

where in Structural Formula (1), R1 represents a hydrocarbon group having 1 to 4 carbon atoms. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, two of Z1 to Z3 are the structure represented by Structural Formula (Z101) below, the structure represented by Structural Formula (Z102) below, or the structure represented by Structural Formula (Z103) below:

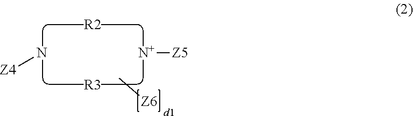

where in Structural Formula (2), R2 and R3 represent a hydrocarbon group needed to form a nitrogen-containing heteroaromatic 5-membered ring together with a nitrogen atom to which each of R2 and R3 is bonded, and d1 represents an integer which is 0 or 1. Z4 to Z6 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z4 to Z6 are the structure represented by Structural Formula (Z101) below, the structure represented by Structural Formula (Z102) below, or the structure represented by Structural Formula (Z103) below:

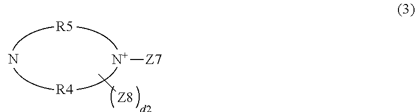

where in Structural Formula (3), R4 and R5 represent a hydrocarbon group needed to form a nitrogen-containing heteroaromatic 6-membered ring together with a nitrogen atom to which each of R4 and R5 is bonded, and d2 represents an integer which is 1 or 2. Z7 and Z8 each independently represent the structure represented by Structural Formula (Z101) below, the structure represented by Structural Formula (Z102) below, the structure represented by Structural Formula (Z103), a hydrogen atom, or a hydrocarbon group having 1 to 4 carbon atoms. However, when d2 is 1, Z7 and Z8 are the structure represented by Structural Formula (Z101) below, the structure represented by Structural Formula (Z102) below, or the structure represented by Structural Formula (Z103) below. When d2 is 2, Z7 and one of Z8 are the structure represented by Structural Formula (Z101), the structure represented by Structural Formula (Z102) below, or the structure represented by Structural Formula (Z103) below, and the other Z8 is a hydrogen atom or a hydrocarbon group having 1 to 4 carbon atoms:

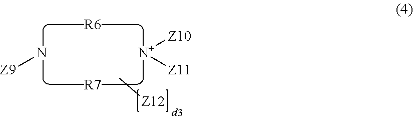

where in Structural Formula (4), R6 and R7 represent a hydrocarbon group needed to form a nitrogen-containing heteroalicyclic group together with a nitrogen atom to which each of R6 and R7 is bonded, and d3 represents an integer which is 0 to 2. Z9 to Z12 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z9 to Z12 are the structure represented by Structural Formula (Z101) below, the structure represented by Structural Formula (Z102) below, or the structure represented by Structural Formula (Z103) below:

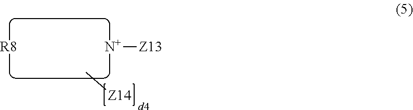

where in Structural Formula (5), R8 represents a hydrocarbon group needed to form a nitrogen-containing aromatic ring together with a nitrogen atom to which R8 is bonded, and d4 represents an integer which is 1 or 2. Z13 and Z14 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms:

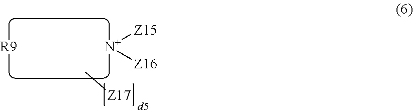

where in Structural Formula (6), R9 represents a hydrocarbon group needed to form a nitrogen-containing heteroalicyclic group together with a nitrogen atom to which R9 is bonded, d5 represents an integer which is 0 or 1, and Z15 to Z17 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z15 to Z17 are the structure represented by Structural Formula (Z101) below, the structure represented by Structural Formula (Z102) below, or the structure represented by Structural Formula (Z103) below:

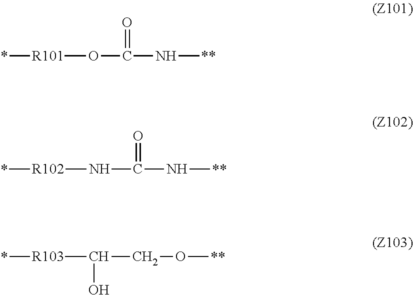

where in Structural Formulas (Z101), (Z102), and (Z103), R101, R102, and R103 each independently represent a linear or branched divalent hydrocarbon group. The symbol “*” represents a bonding portion with a nitrogen atom in Structural Formula (1) or represents a bonding portion with a nitrogen atom or a carbon atom in the nitrogen-containing heterocyclic ring in Structural Formulas (2) to (6). The symbol “**” represents a bonding portion with a carbon atom in a polymer chain of the polyurethane.

According to at least one aspect of the present disclosure, there is provided a developing device comprising at least:
a developing roller and a developer supply roller that supplies a developer to the developing roller, wherein
the developing device is configured such that a voltage is applicable between the developing roller and the developer supply roller, and
the developer supply roller is the above foam roller.

According to at least one aspect of the present disclosure, there is provided an electrophotographic image forming apparatus comprising the above developing device.

Moreover, according to at least one aspect of the present disclosure, there is provided a process cartridge that is attachable to and detachable from a main body of an electrophotographic image forming apparatus, the process cartridge comprising:
a contact member that is electrically connected to an electric contact of the main body when the process cartridge is mounted on the main body;
a developing roller; and a developer supply roller that supplies a developer to the developing roller, wherein
the process cartridge is configured such that a voltage is applicable between the developing roller and the developer supply roller through electrical connection to the main body,
the developer supply roller is the above foam roller.

According to at least one aspect of the present disclosure, it is possible to provide a foam roller which contributes to formation of an electrophotographic image with high quality even immediately after stopping for a long period of time in a low-temperature low-humidity environment. Also, according to at least one aspect of the present disclosure, it is possible to provide a developing device, an electrophotographic image forming apparatus, and a process cartridge which contribute to formation of an electrophotographic image with high quality even immediately after stopping for a long period of time in a low-temperature low-humidity environment.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of a foam roller.

FIG. 2 is a schematic configuration diagram of an electrophotographic image forming apparatus.

FIG. 3 is a schematic configuration diagram illustrating a process cartridge.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ. Here, when XX is a group, a plurality of XXs may be selected, and the same applies to YY and ZZ.

If a foam roller used in an electrophotographic image forming apparatus is stopped for a long period of time in a low-temperature low-humidity environment, a portion abutting on a developing roller may be compressed, and a depression may be generated. It takes time to restore the generated depressed portion because of the low-temperature environment, and toner supply performance is likely to be degraded. A foam roller with a low apparent density has a small material skeleton portion, thus requires a particularly long time for the restoring, and is more likely to cause degradation of toner supply performance.

According to the investigation made by the present inventors, it has been found to be important to form an ion aggregate in a foam layer of the foam roller in order to maintain an electrophotographic image with high quality without causing degradation of toner supply performance even after stopping for a long period of time in a low-temperature low-humidity environment. It should be noted that the ion aggregate in the present disclosure refers to a state where a plurality of anions and a plurality of cations are aggregated through ion bonding.

Furthermore, the present inventors have discovered that in order to form an ion aggregate in the foam layer of the foam roller, it is important to satisfy the following requirements (1), (2), and (3).
(1) To select anions with high electron densities to thereby strongly attract anions around the cations.
(2) To select bifunctional cations to thereby form a space where anions enter around the cations.
(3) To reduce factors with an effect of attracting anions, such as alkali metal ions and alkaline-earth metal ions.

By satisfying (1), (2), and (3) described above, the ion aggregate is formed in the foam layer of the foam roller, and a depression is unlikely to be generated at the portion abutting on the developing roller even after stopping for a long period of time in a low-temperature low-humidity environment. It has been found to be possible to obtain a foam roller capable of maintaining an electrophotographic image with high quality without causing degradation of toner supply performance as a result.

Embodiments to implement the present disclosure will be specifically described below.

The foam roller comprises a conductive substrate and a foam layer on the substrate, and the foam layer comprises polyurethane comprising a urethane bond and an anion.

The polyurethane comprised in the foam layer comprises at least one selected from the group consisting of a cationic structure represented by Structural Formula (1) above, a cationic structure represented by Structural Formula (2) above, a cationic structure represented by Structural Formula (3) above, a cationic structure represented by Structural Formula (4) above, a cationic structure represented by Structural Formula (5) above, and a cationic structure represented by Structural Formula (6) above. All of the cationic structures represented by Structural Formulas (1) to (6) above are bifunctional cationic structures.

The cationic structure represented by Structural Formula (1) above has a high electron density of the cation, is likely to attract anions, and is likely to form an ion aggregate. The cationic structures represented by Structural Formulas (2) to (6) above have wide ranges in which anions are attracted by electron conjugation of a nitrogen-containing aromatic ring, thus making it easy to connect anion-cation bonds and form an ion aggregate. In other words, it is possible to satisfy the above requirement (2) by polyurethane in the foam layer comprising at least one selected from the group consisting of the cationic structures represented by Structural Formulas (1) to (6) above.

Also, the anion comprised in the foam layer comprises a bis(fluorosulfonyl)imide anion. Since the anion has a large electron density, the anion is likely to be strongly attracted around the cation, and an ion aggregate is likely to be formed. In other words, it is possible to satisfy the above requirement (1) by the foam layer comprising a bis(fluorosulfonyl)imide anion.

Furthermore, when the sum of the content of alkali metal and alkaline-earth metal in the foam layer, which are extracted by immersing the foam layer in acetone, is defined as A (mol/g), and the sum of the content of anion in the foam layer, which is extracted by immersing the foam layer in acetone, is defined as B (mol/g), A/B is 0.0400 or less.

According to the investigation made by the present inventors, alkali metal ions and alkaline-earth metal ions are likely to inhibit formation of ion bonding between cations and anions by electrically attracting the above-described anions. It is thus estimated that if the foam layer comprises large numbers of alkali metal ions and alkaline-earth metal ions, the ion aggregate is not sufficiently formed, it takes time for polyurethane to be restored from deformation due to compression, and degradation of toner supply performance is likely to occur.

A/B of 0.0400 or less indicates that the ratio of the content of alkali metal and alkaline-earth metal with respect to the total amount of anions in the foam layer is small. In other words, it is possible to satisfy the above requirement (3) by controlling the value of A/B to 0.0400 or less. It is considered that by reducing the content of alkali metal and alkaline-earth metal in the foam layer, the ion aggregate is more likely to be formed, and it is possible to improve shape restorability of the foam layer.

In this manner, the configuration of the present disclosure can achieve the above-described requirements (1), (2), and (3) at the same time. Specifically, by satisfying all the above-described requirements (1), (2), and (3), the cations and the anions strongly attract each other, an ion aggregate in which the plurality of anions and the plurality of cations aggregate through ion bonding is likely to be formed, and it is possible to enhance restorability when a depression is generated in the foam layer. Therefore, it is possible to obtain a foam roller having excellent toner supply performance even after stopping for a long period of time in a low-temperature low-humidity environment where restorability is likely to be degraded.

### Foam Roller

The foam roller comprises a conductive substrate and a foam layer on the substrate.

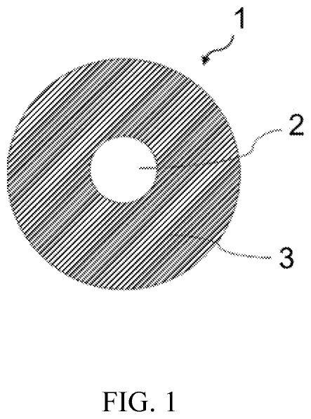

An example of a configuration of the foam roller is illustrated in FIG. 1. The foam roller 1 illustrated in FIG. 1 is configured of a conductive substrate 2 and a foam layer 3 which is a foam provided on an outer surface of the substrate 2. The foam roller may comprise another layer such as an adhesive layer between the substrate and the foam layer.

The foam roller can be used as a developer supply roller for supplying a developer to a developing roller. The foam roller can be suitably used particularly as a toner supply roller used in an electrophotographic image forming apparatus.

Hereinafter, a configuration of the foam roller according to an aspect of the present disclosure will be described in detail.

### Substrate

The substrate 2 is conductive and functions as a support member of the foam roller and an electrode. The substrate 2 is made of, for example, a conductive material such as metal or an alloy such as aluminum, a copper alloy, or stainless steel; iron plated with chromium or nickel; or a conductive synthetic resin. The substrate 2 is, for example, stainless steel. The substrate 2 preferably has a solid cylindrical columnar shape or a hollow cylindrical shape.

### Foam Layer

Although the shape of the foam layer is not particularly limited, the foam layer is preferably attached to cover the outer periphery of the substrate in a tubular shape. As described above, the foam roller comprising the foam layer can be suitably used as a toner supply roller. The toner supply roller is required to have performance for supplying a toner uniformly to the surface of the developing roller, and characteristics such as an average cell diameter, the number of cells, and the air flow amount on the surface of the foam layer, the density of the entire foam layer, and the like are important.

The foam layer has an apparent density of 0.03 to 0.25 g/cm³. The apparent density of the foam layer is preferably 0.05 to 0.24 g/cm³, and is more preferably 0.07 to 0.20 g/cm³. Note that the apparent density of the foam layer in the present disclosure refers to a value obtained by dividing the mass of the foam layer by the volume of the foam layer.

The smaller the apparent density of the conductive foam layer is, the larger the void space becomes, and it is thus possible to improve developer transport performance. In other words, it is possible to improve toner supply performance by the apparent density of the foam layer falling within the above-described range.

On the other hand, since the amount of skeleton portion decreases as the apparent density is reduced, a trade-off in which restorability at the time of compression is degraded and irregularity of developer supply depending on a roller cycle is likely to be caused at a portion abutting on the developing roller is present.

In order to address the above problems, the present inventors has discovered that it is possible to maintain restorability of the foam layer at the time of compression even in a configuration comprising a small amount of skeleton portion with an apparent density of 0.25 g/cm³ or less, by adopting the following configuration for the foam layer.

The foam layer comprises polyurethane comprising a urethane bond and an anion.

The polyurethane comprises at least one cationic structure selected from the group consisting of bifunctional cationic structures represented by Structural Formulas (1) to (6) below.

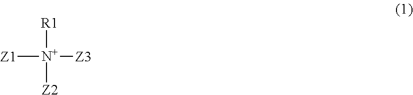

In Structural Formula (1), R1 represents a hydrocarbon group having 1 to 4 carbon atoms. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, two of Z1 to Z3 are the structure represented by Structural Formula (Z101) below, the structure represented by Structural Formula (Z102) below, or the structure represented by Structural Formula (Z103) below.

As the hydrocarbon group having 1 to 4 carbon atoms, an alkyl group is preferably used, an alkyl group having 1 or 2 carbon atoms is more preferably used, and an alkyl group having 1 carbon atom is further preferably used. R1 is preferably —CH₃.

In Structural Formula (1), Z1 and Z3 are preferably a structure represented by Structural Formula (Z101) below, a structure represented by Structural Formula (Z102) below, or a structure represented by Structural Formula (Z103) below. It is more preferable that both Z1 and Z3 be the structure represented by Structural Formula (Z101) or the structure represented by Structural Formula (Z102).

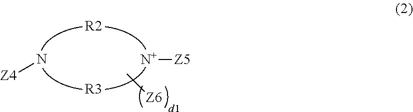

In Structural Formula (2), R2 and R3 represent a hydrocarbon group needed to form a nitrogen-containing heteroaromatic 5-membered ring together with a nitrogen atom to which each of R2 and R3 is bonded, and d1 represents an integer which is 0 or 1. Z4 to Z6 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z4 to Z6 are the structure represented by Structural Formula (Z101) below, the structure represented by Structural Formula (Z102) below, or the structure represented by Structural Formula (Z103) below.

As the hydrocarbon group having 1 to 4 carbon atoms, an alkyl group is preferably used, an alkyl group having 1 or 2 carbon atoms is more preferably used, and an alkyl group having 1 carbon atom is further preferably used. The nitrogen-containing heterocyclic structure in Structural Formula (2) is preferably an imidazolium cation, for example.

In Structural Formula (2), Z4 and Z5 are preferably the structure represented by Structural Formula (Z101) below, the structure represented by Structural Formula (Z102) below, or the structure represented by Structural Formula (Z103) below. It is preferable that both Z4 and Z5 be the structure represented by Structural Formula (Z101) below or the structure represented by Structural Formula (Z102) below.

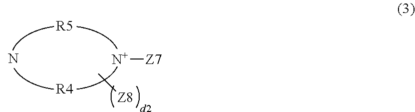

In Structural Formula (3), R4 and R5 represent a hydrocarbon group necessary to form a nitrogen-containing heteroaromatic 6-membered ring together with a nitrogen atom to which each of R4 and R5 is bonded, and d2 represents an integer which is 1 or 2. When d2 is 2, Z8 may be the same or different.

Z7 and Z8 each independently represent the structure represented by Structural Formula (Z101) below, the structure represented by Structural Formula (Z102) below, the structure represented by Structural Formula (Z103), a hydrogen atom, or a hydrocarbon group having 1 to 4 carbon atoms. However, when d2 is 1, Z7 and Z8 are the structure represented by Structural Formula (Z101) below, the structure represented by Structural Formula (Z102) below, or the structure represented by Structural Formula (Z103) below. When d2 is 2, Z7 and one of Z8 are the structure represented by Structural Formula (Z101), the structure represented by Structural Formula (Z102) below, or the structure represented by Structural Formula (Z103) below, and the other Z8 is a hydrogen atom or a hydrocarbon group having 1 to 4 carbon atoms.

As the hydrocarbon group having 1 to 4 carbon atoms, an alkyl group is preferably used, an alkyl group having 1 or 2 carbon atoms is more preferably used, and an alkyl group having 1 carbon atom is further preferably used.

When d2 is 2, it is preferred that both Z7 and Z8 bonded to a nitrogen-containing heterocyclic structure be the structure represented by Structural Formula (Z101) below or the structure represented by Structural Formula (Z102) below. When d2 is 2, Z8 that is not bonded to the nitrogen-containing heterocyclic structure is preferably —CH₃, for example.

The nitrogen-containing heterocyclic structure of Structural Formula (3) is preferably a pyrazinium cation or a pyrimidinium cation, for example.

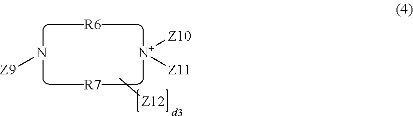

In Structural Formula (4), R6 and R7 represent a hydrocarbon group needed to form a nitrogen-containing heteroalicyclic group together with a nitrogen group to which each of R6 and R7 is bonded. d3 represents an integer which is 0 to 2, and when d3 is 2, Z12 may be the same or different.

Z9 to Z12 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z9 to Z12 are the structure represented by Structural Formula (Z101) below, the structure represented by Structural Formula (Z102) below, or the structure represented by Structural Formula (Z103) below.

As the hydrocarbon group having 1 to 4 carbon atoms, an alkyl group is preferably used, an alkyl group having 1 or 2 carbon atoms is more preferably used, and an alkyl group having 1 carbon atom is further preferably used. The nitrogen-containing heterocyclic structure of Structural Formula (4) is preferably a piperazinium cation, for example.

In Structural Formula (4), Z9 and Z11 are preferably the structure represented by Structural Formula (Z101) below, the structure represented by Structural Formula (Z102) below, or the structure represented by Structural Formula (Z103) below. It is preferable that both Z9 and Z11 be the structure represented by Structural Formula (Z101) below or the structure represented by Structural Formula (Z102) below.

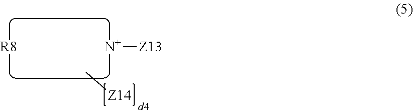

In Structural Formula (5), R8 represents a hydrocarbon group needed to form a nitrogen-containing aromatic ring together with a nitrogen atom to which R8 is bonded, and d4 represents an integer which is 1 or 2. Z13 and Z14 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms.

As the hydrocarbon group having 1 to 4 carbon atoms, an alkyl group is preferably used, an alkyl group having 1 or 2 carbon atoms is more preferably used, and an alkyl group having 1 carbon atom is further preferably used.

The nitrogen-containing heterocyclic structure of Structural Formula (5) is preferably a pyridinium cation, for example.

d4 in Structural Formula (5) is preferably 1. When d4 is 1, it is preferable that both Z13 and Z14 be the structure represented by Structural Formula (Z101) below or the structure represented by Structural Formula (Z102) below.

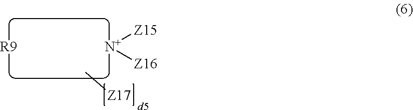

In Structural Formula (6), R9 represents a hydrocarbon group needed to form a nitrogen-containing heteroalicyclic group together with a nitrogen atom to which R9 is bonded, d5 represents an integer which is 0 or 1. Z15 to Z17 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z15 to Z17 are the structure represented by Structural Formula (Z101) below, the structure represented by Structural Formula (Z102) below, or the structure represented by Structural Formula (Z103) below.

As the hydrocarbon group having 1 to 4 carbon atoms, an alkyl group is preferably used, an alkyl group having 1 or 2 carbon atoms is more preferably used, and an alkyl group having 1 carbon atom is further preferably used. The nitrogen-containing heterocyclic structure of Structural Formula (6) is preferably a pyrrolidinium cation, for example.

d5 in Structural Formula (6) is preferably 1. When d5 is 1, it is preferable that both Z16 and Z17 be the structure represented by Structural Formula (Z101) below or the structure represented by Structural Formula (Z102) below.

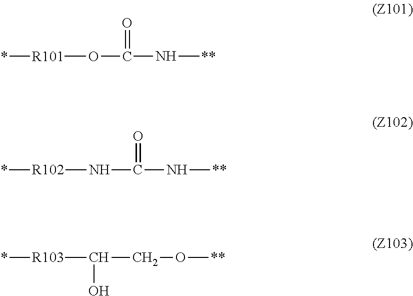

In Structural Formulas (Z101), (Z102), and (Z103), R101, R102, and R103 each independently represent a linear or branched divalent hydrocarbon group. The symbol “*” represents a bonding portion with a nitrogen atom in Structural Formula (1) or represents a bonding portion with a nitrogen atom or a carbon atom in the nitrogen-containing heterocyclic ring in Structural Formulas (2) to (6). The symbol “**” represents a bonding portion with a carbon atom in a polymer chain of the polyurethane.

The divalent hydrocarbon group is preferably a linear or branched alkylene group having 1 to 8 carbon atoms, is more preferably an alkylene group having 1 to 4 carbon atoms, and is further preferably an alkylene group having 1 or 2 carbon atoms. R101, R102 and R103 are preferably —CH₂—, —C₂H₄—, or —C₄H₈—.

### Concerning Formation of Cationic Structure and Ion Aggregate

In polyurethane using an ion compound composed of anions and precursors of cationic structures, the negatively charged anions are attracted by the positively charged cationic structures to thereby form ion bonding. It is possible to promote the formation of the ion bonding around the cationic structures by combining anions with a high electron density and bifunctional cationic structures.

In addition, since the cationic structures represented by Structural Formula (1) have a positive charge locally on the nitrogen atoms, the effect of promoting the formation of the ion bonding is likely to strongly act. As a result, a plurality of anion molecules are attracted to the periphery of one cationic structure and a plurality of cationic structures are also attracted to the periphery thereof in such a way that excess negative charges of the attracted anion molecules are compensated, and it is thus easy to form the above-described ion aggregate.

In the case of the cationic structure comprising the cationic nitrogen-containing heteroaromatic ring represented by Structural Formulas (2) to (6), the positive charges on the nitrogen atom are also distributed on other atoms on the aromatic ring while distributed mainly on the nitrogen atom through conjugation. The plurality of anion molecules with a strong effect of forming ion bonding are attracted to the periphery of one cationic structure by the positive charges being present in a distributed manner. Also, since the plurality of cationic structures are also attracted to the periphery thereof in such a way that the excess negative charges of the attracted anion molecules are compensated, it is easy to form the ion aggregate.

The ion aggregate is likely to be formed in the foam layer by the polyurethane comprising a bifunctional cationic structure represented by any of Structural Formulas (1) to (6) and a bis(fluorosulfonyl)imide anion with a high electron density. It is possible to improve restorability of the polyurethane when deformation occurs, by forming the ion aggregate derived from the ion bonding in the polyurethane. It is considered that the ion aggregate crosslinks molecular chains of the polyurethane in a pseudo manner by the ion bonding, the pseudo crosslinking includes a large elastic component, and it is thus considered to be possible to improve restorability of the polyurethane. In a low-temperature environment, in particular, strong ion bonding is likely to be formed due to a decrease in molecular mobility, and it is thus possible to further improve restorability of the shape of the foam layer by comprising the above-described polyurethane.

### Polyurethane

The polyurethane comprised in the foam layer of the foam roller has a urethane bond. The polyurethane comprises at least one bifunctional cationic structure selected from the group consisting of the structures represented by Structural Formulas (1) to (6) above. The polyurethane functions as a carrier for anions that are in charge of conductivity. Note that the foam layer may comprise a resin different from the resin having the cationic structure.

The polyurethane comprising the above-described cationic structure is, for example, a reaction product of a compound comprising a cationic structure and a polyurethane raw material mixture for forming polyurethane. The polyurethane raw material mixture comprises, for example, compounds other than the compounds comprising the above-described cationic structure, preferably polyol and polyisocyanate. The compound comprising the cationic structure is preferably an ion compound comprising the cationic structure represented by Structural Formulas (1) to (6) above and an anion.

The compound comprising the cationic structure preferably has two functional groups including a hydroxyl group, an amino group, or a glycidyl group. The hydroxyl group or the amino group reacts with an isocyanate group of the compound comprising the cationic structure to form a bond. Therefore, it is possible to introduce the above-described cationic structure into the urethane molecule structure through the reaction between the compound comprising the cationic structure and polyisocyanate, for example. The glycidyl group reacts with a hydroxyl group of the compound comprising the cationic structure to form a bond. Therefore, it is possible to introduce the above-described cationic structure into the urethane molecule structure through the reaction between the compound comprising the cationic structure and polyol.

### Cationic Structure

The compound comprising a cationic structure to be used to form polyurethane has at least one bifunctional cationic structure selected from the group consisting of the structures represented by Structural Formulas (1) to (6) above. Hereinafter, each of the structures represented by Structural Formulas (1) to (6) will be described.

The structure represented by Structural Formula (1) may be formed by an ammonium cation having two functional groups including a hydroxyl group, an amino group, or a glycidyl group. In a case where the structure represented by Structural Formula (1) is an ammonium cation having two functional groups including a hydroxyl group, a structure having at least two structures represented by Structural Formula (Z101) can be obtained by causing an ion compound corresponding to the cation to react with an isocyanate group.

In a case where the structure represented by Structural Formula (1) is an ammonium cation having two functional groups including an amino group, a structure having at least two structures represented by Structural Formula (Z102) can be obtained by causing an ion compound corresponding to the cation to react with an isocyanate group.

In a case where the structure represented by Structural Formula (1) is an ammonium cation having two functional groups including a glycidyl group, a structure having at least two structures represented by Structural Formula (Z103) can be obtained by causing an ion compound corresponding to the cation to react with a hydroxyl group.

Examples of the compound that may form the structure represented by Structural Formula (1) include the following ammonium cations having a hydroxyl group:
bis(hydroxymethyl)dimethylammonium cation, bis(2-hydroxyethyl)dimethylammonium cation, bis(3-hydroxypropyl)dimethylammonium cation, bis(4-hydroxybutyl)dimethylammonium cation, bis(8-hydroxyoctyl)dimethylammonium cation, bis(8-hydroxyoctyl)-di-n-butylammonium cation; and derivatives thereof.

Examples of the ammonium cation having two amino groups or glycidyl groups include a cation having a structure in which the hydroxyl group of the above-described cation is substituted with an amino group or a glycidyl group.

The structure represented by Structural Formula (2) may be formed by a nitrogen-containing heteroaromatic 5-membered ring cation having two functional groups including a hydroxyl group, an amino group, or a glycidyl group and including two nitrogen atoms. In a case where the structure represented by Structural Formula (2) is a nitrogen-containing heteroaromatic 5-membered ring cation having two functional groups including a hydroxyl group, a structure having at least two structures represented by Structural Formula (Z101) can be obtained by causing an ion compound corresponding to the nitrogen-containing heteroaromatic 5-membered ring cation to react with an isocyanate group.

In a case where the structure indicated by Structural Formula (2) is a nitrogen-containing heteroaromatic 5-membered ring cation having two functional groups including an amino group, a structure having at least two structures represented by Structural Formula (Z102) can be obtained by causing an ion compound corresponding to the cation to react with an isocyanate group.

In a case where the structure represented by Structural Formula (2) is a nitrogen-containing heteroaromatic 5-membered ring cation having two functional groups including a glycidyl group, a structure having at least two structures represented by Structural Formula (Z103) can be obtained by causing an ion compound corresponding to the cation to react with a hydroxyl group.

As the nitrogen-containing heteroaromatic 5-membered ring in the structure represented by Structural Formula (2), imidazolium is preferably used. The structure represented by Structural Formula (2) is more preferably a cationic structure having an imidazoline ring represented by Structural Formula (7) below.

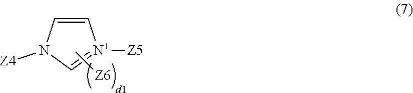

In Structural Formula (7), d1 represents an integer which is 0 or 1. Z4 to Z6 each independently represent the structure represented by Structural Formula (Z101) above, the structure represented by Structural Formula (Z102) above, the structure represented by Structural Formula (Z103) above, a hydrogen atom, or a hydrocarbon group having 1 to 4 carbon atoms. However, two of Z4 to Z6 are the structure represented by Structural Formula (Z101) above, the structure represented by Structural Formula (Z102) above, or the structure represented by Structural Formula (Z103) above. As the hydrocarbon group having 1 to 4 carbon atoms, an alkyl group is preferably used, an alkyl group having 1 or 2 carbon atoms is more preferably used, and an alkyl group having 1 carbon atom is further preferably used.

Examples of the compound that may form the structure represented by Structural Formula (2) include the following cations having an imidazoline ring structure and a hydroxyl group:
1,3-bis(hydroxymethyl) imidazolium cation, 1,3-bis(2-hydroxyethyl) imidazolium cation, 2-methyl-1,3-bis(hydroxymethyl) imidazolium cation, 2-methyl-1,3-bis(2-hydroxyethyl) imidazolium cation, 4-methyl-1,3-bis(2-hydroxyethyl) imidazolium cation, 2-ethyl-1,3-bis(2-hydroxyethyl) imidazolium cation, 4-ethyl-1,3-bis(2-hydroxyethyl) imidazolium cation, 2-n-butyl-1,3-bis(2-hydroxyethyl) imidazolium cation, 4-n-butyl-1,3-bis(2-hydroxyethyl) imidazolium cation, 1,3-bis(3-hydroxypropyl) imidazolium cation, 1,3-bis(4-hydroxybutyl) imidazolium cation, 1,3-bis(6-hydroxyhexyl) imidazolium cation, 1,3-bis(8-hydroxyoctyl) imidazolium cation, 1-methyl-2,3-bis(2-hydroxyethyl) imidazolium cation, 1-methyl-3,4-bis(2-hydroxyethyl) imidazolium cation, 1-methyl-3,5-bis(2-hydroxyethyl) imidazolium cation; and derivatives thereof.

Examples of the cation having two amino groups or glycidyl groups include a cation having a structure in which the hydroxyl group of the above-described cation is substituted with an amino group or a glycidyl group.

The structure represented by Structural Formula (3) may be formed by a nitrogen-containing heteroaromatic 6-membered ring cation having two functional group including a hydroxyl group, an amino group, or a glycidyl group and including two nitrogen atoms. In a case where the structure represented by Structural Formula (3) is a nitrogen-containing heteroaromatic 6-membered ring cation having two functional group including a hydroxyl group, a structure having at least two structures represented by Structural Formula (Z101) can be obtained by causing an ion compound corresponding to the cation to react with an isocyanate group.

In a case where the structure indicated by Structural Formula (3) is a nitrogen-containing heteroaromatic 6-membered ring cation having two functional groups including an amino group, a structure having at least two structures represented by Structural Formula (Z102) can be obtained by causing an ion compound corresponding to the cation to react with an isocyanate group.

In a case where the structure represented by Structural Formula (3) is a nitrogen-containing heteroaromatic 6-membered ring cation having two functional groups including a glycidyl group, a structure having at least two structures represented by Structural Formula (Z103) can be obtained by causing an ion compound corresponding to the cation to react with a hydroxyl group.

Examples of the nitrogen-containing heteroaromatic 6-membered ring in the structure represented by Structural Formula (3) include a pyrimidine ring and a pyrazine ring.

Examples of the compound that may form the structure represented by Structural Formula (3) include the following cations having a pyrimidine ring structure and a hydroxyl group:

1,4-bis(2-hydroxyethyl)pyrimidinium cation, 1,5-bis(3-hydroxypropyl)pyrimidinium cation, 1-(4-hydroxybutyl)-4-(2-hydroxyethyl)pyrimidinium cation, 1,4-bis(2-hydroxyethyl)-2-methylpyrimidinium cation; and derivatives thereof.

Examples of the cation having two amino groups or glycidyl groups include a cation having a structure in which the hydroxyl group of the above-described cation is substituted with an amino group or a glycidyl group.

The structure represented by Structural Formula (4) may be formed by a nitrogen-containing heteroalicyclic cation having two functional groups including a hydroxyl group, an amino group, or a glycidyl group and including two nitrogen atoms. In a case where the structure represented by Structural Formula (4) is a nitrogen-containing heteroalicyclic cation having two functional groups including a hydroxyl group, a structure having at least two structures represented by Structural Formula (Z101) can be obtained by causing an ion compound corresponding to the cation to react with an isocyanate group.

In a case where the structure represented by Structural Formula (4) is a nitrogen-containing heteroalicyclic cation having two functional groups including an amino group, a structure having at least two structures represented by Structural Formula (Z102) can be obtained by causing an ion compound corresponding to the cation to react with an isocyanate group.

In a case where the structure represented by Structural Formula (4) is a nitrogen-containing heteroalicyclic cation having two functional groups including a glycidyl group, a structure having at least two structures represented by Structural Formula (Z103) can be obtained by causing an ion compound corresponding to the cation to react with a hydroxyl group.

Examples of the nitrogen-containing heteroalicyclic group in the structure represented by Structural Formula (4) include a piperazine group, an imidazoline group, an imidazolidine group, a 1,3-diazepane group, and a 1,4-diazepane group. Among these, a piperazine group is preferably used. The structure represented by Structural Formula (4) is preferably a cationic structure represented by Structural Formula (8) below.

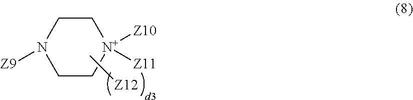

In Structural Formula (8), d3 represents an integer which is 0 to 2, and when d3 is 2, Z12 may be the same or different. Z9 to Z12 each independently represent the structure represented by Structural Formula (Z101) above, the structure represented by Structural Formula (Z102) above, the structure represented by Structural Formula (Z103) above, a hydrogen atom, or a hydrocarbon group having 1 to 4 carbon atoms. However, two of Z9 to Z12 are the structure represented by Structural Formula (Z101) above, the structure represented by Structural Formula (Z102) above, or the structure represented by Structural Formula (Z103) above. As the hydrocarbon group having 1 to 4 carbon atoms, an alkyl group is preferably used, an alkyl group having 1 or 2 carbon atoms is more preferably used, and an alkyl group having 1 carbon atom is further preferably used.

Examples of the compound that may form the structure represented by Structural Formula (4) include the following compounds:
1,1-bis(2-hydroxyethyl) piperazinium cation, 1,4-bis(3-hydropropyl)-1-ethylpiperazinium cation, 1,4-bis(2-hydroxyethyl)-1,3-diethylpiperazinium cation; and derivatives thereof.

Examples of the cation having two amino groups or glycidyl groups include a cation having a structure in which the hydroxyl group of the above-described cation is substituted with an amino group or a glycidyl group.

The structure represented by Structural Formula (5) may be formed by a nitrogen-containing aromatic ring cation having two functional groups including a hydroxyl group, an amino group, or a glycidyl group and one nitrogen atom.

In a case where the structure represented by Structural Formula (5) is a nitrogen-containing aromatic ring cation having two functional groups including a hydroxyl group, a structure having at least two structures represented by Structural Formula (Z101) can be obtained by causing an ion compound corresponding to the cation to react with an isocyanate group.

In a case where the structure represented by Structural Formula (5) is a nitrogen-containing aromatic ring cation having two functional groups including an amino group, a structure having at least two structures represented by Structural Formula (Z102) can be obtained by causing an ion compound corresponding to the cation to react with an isocyanate group.

In a case where the structure represented by Structural Formula (5) is a nitrogen-containing aromatic ring cation having two functional groups including a glycidyl group, a structure having at least two structures represented by Structural Formula (Z103) can be obtained by causing an ion compound corresponding to the cation to react with a hydroxyl group.

Examples of the nitrogen-containing aromatic ring in the structure represented by Structural Formula (5) include a pyrrole ring, a pyridine ring, and an azepine ring. Among them, a pyridine ring is preferably used. The structure represented by Structural Formula (5) is preferably a cationic structure represented by Structural Formula (9).

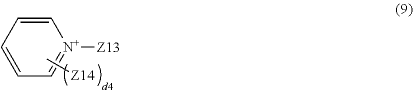

In Structural Formula (9), d4 is an integer which is 1 or 2, Z13 and Z14 each independently represent the structure represented by Structural Formula (Z101) above, the structure represented by Structural Formula (Z102) above, the structure represented by Structural Formula (Z103) above, a hydrogen atom, or a hydrocarbon group having 1 to 4 carbons. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of the elements Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms.

As the hydrocarbon group having 1 to 4 carbon atoms, an alkyl group is preferably used, an alkyl group having 1 or 2 carbon atoms is more preferably used, and an alkyl group having 1 carbon atom is further preferably used.

Examples of the compound that may form the structure represented by Structural Formula (5) include the following cations having a pyridine ring structure and a hydroxyl group:
1,2-bis(hydroxymethyl)pyridinium cation, 1,3-bis(hydroxymethyl)pyridinium cation, 1,4-bis(hydroxymethyl)pyridinium cation, 1,2-bis(2-hydroxyethyl)pyridinium cation, 1,3-bis(2-hydroxyethyl)pyridinium cation, 1,4-bis(2-hydroxyethyl)pyridinium cation, 1,2-bis(3-hydroxypropyl)pyridinium cation, 1,3-bis(3-hydroxypropyl)pyridinium cation, 1,4-bis(3-hydroxypropyl)pyridinium cation, 1,2-bis(4-hydroxybutyl)pyridinium cation, 1,3-bis(4-hydroxybutyl)pyridinium cation, 1,4-bis(4-hydroxybutyl)pyridinium cation, 1,2-bis(6-hydroxyhexyl)pyridinium cation, 1,3-bis(6-hydroxyhexyl)pyridinium cation, 1,4-bis(6-hydroxyhexyl)pyridinium cation, 1,2-bis(8-hydroxyoctyl)pyridinium cation, 1,3-bis(8-hydroxyoctyl)pyridinium cation, 1,4-bis(8-hydroxyoctyl)pyridinium cation, 2-methyl-1,3-bis(2-hydroxyethyl)pyridinium cation, 2-ethyl-1,3-bis(2-hydroxyethyl)pyridinium cation, 5-methyl-1,3-bis(2-hydroxyethyl)pyridinium cation, 5-ethyl-1,3-bis(2-hydroxyethyl)pyridinium cation; and derivatives thereof.

Examples of the cation having two amino groups or glycidyl groups include a cation having a structure in which the hydroxyl group of the above-described cation is substituted with an amino group or a glycidyl group.

The structure represented by Structural Formula (6) may be formed by a nitrogen-containing alicyclic cation having two functional groups including a hydroxyl group, an amino group, or a glycidyl group.

In a case where the structure represented by Structural Formula (6) is a nitrogen-containing alicyclic cation having two functional group including a hydroxyl group, a structure having at least two structures represented by Structural Formula (Z101) can be obtained by causing an ion compound corresponding to the cation to react with an isocyanate group.

In a case where the structure represented by Structural Formula (6) is a nitrogen-containing alicyclic cation having two functional groups including an amino group, a structure having at least two structures represented by Structural Formula (Z102) can be obtained by causing an ion compound corresponding to the cation to react with an isocyanate group.

In a case where the structure represented by Structural Formula (6) is a nitrogen-containing alicyclic cation having two functional groups including a glycidyl group, a structure having at least two structures represented by Structural Formula (Z103) can be obtained by causing an ion compound corresponding to the cation to react with a hydroxyl group.

Examples of the nitrogen-containing alicyclic group in the structure represented by Structural Formula (6) include a pyrrolidine group, a pyrroline group, a piperidine group, an azepane group, and an azocan group. Among these, a pyrrolidine group is preferably used. The structure represented by Structural Formula (6) is preferably a cationic structure represented by Structural Formula (10) below.

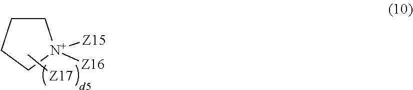

In Structural Formula (10), d5 represents an integer which is 0 or 1. Z15 to Z17 each independently represent the structure represented by Structural Formula (Z101) above, the structure represented by Structural Formula (Z102) above, the structure represented by Structural Formula (Z103) above, a hydrogen atom, or a hydrocarbon group having 1 to 4 carbon atoms. However, two of Z15 to Z17 are the structure represented by Structural Formula (Z101) above, the structure represented by Structural Formula (Z102) above, or the structure represented by Structural Formula (Z103) above. As the hydrocarbon group having 1 to 4 carbon atoms, an alkyl group is preferably used, an alkyl group having 1 to 2 carbon atoms is more preferably used, and an alkyl group having 1 carbon atom is further preferably used.

Examples of the compound that may form the structure represented by Structural Formula (6) include the following cations having a pyrrolidine group and a hydroxyl group:
1-methyl-1,2-bis(2-hydroxyethyl) pyrrolidinium cation, 1-ethyl-1,2-bis(2-hydroxyethyl) pyrrolidinium cation, 1-butyl-1,2-bis(2-hydroxyethyl) pyrrolidinium cation, and 1-methyl-1,2-bis(4-hydroxybutyl) pyrrolidinium cation; and derivatives thereof.

Examples of the cation having two amino groups or glycidyl groups include a cation with a structure in which a hydroxyl group of the above-described cation is substituted with an amino group or a glycidyl group.

The structure represented by Structural Formula (Z101) is a residue formed through a reaction between a hydroxyl group that the cation has and an isocyanate group. The structure represented by Structural Formula (Z102) is a residue formed through a reaction between an amino group that the cation has and an isocyanate group. The isocyanate group that reacts with a hydroxyl group or an amino group is preferably an isocyanate group that a raw material, such as polyisocyanate, in the polyurethane raw material mixture has.

The structure represented by Structural Formula (Z103) is a residue formed through a reaction between a glycidyl group that the cation has and a hydroxyl group. The hydroxyl group that reacts with the glycidyl group is preferably a hydroxyl group that a raw material, such as polyisocyanate in the polyurethane raw material mixture has.

Among the structures represented by Structural Formulas (1) to (6), the polyurethane preferably has the structure represented by Structural Formula (2). Also, the polyurethane preferably has the structure represented by Structural Formula (7) among structures represented by Structural Formula (2).

In a case where the polyurethane has the structure represented by Structural Formula (2) or (7), an excellent balance between an electron density and a positive charge distribution range due to conjugation is achieved as a chemical structure of the cation, which is suitable for the formation of the ion aggregate. This is preferable because the ion aggregate is more likely to be formed in the polyurethane and it is possible to further enhance the effect of improving shape restorability of the foam roller.

### Anion

The foam layer comprises an anion. It is possible to apply conductivity to the foam layer by the foam layer comprising the anion. The anion comprises a bis(fluorosulfonyl)imide anion.

The bis(fluorosulfonyl)imide anion is chemically much more stable than a halogen anion, a sulfate anion, and a nitrate anion due to its chemical structure. Specifically, the bis(fluorosulfonyl)imide anion has a strong electron-withdrawing group in the molecule, stabilizes a negative charge of the anion, and thus has a strong electric attraction. Therefore, it is considered that the anion is strongly attracted to the periphery of the cation by the anion including the bis(fluorosulfonyl)imide anion, which contributes to the formation of the ion aggregate.

### Polyurethane Raw Material Mixture

The foam layer of the foam roller comprises polyurethane comprising a urethane bond and an anion. In particular, a thermosetting polyether polyurethane is suitably used because it has flexibility as well.

Although a method for obtaining the polyurethane comprising the cationic structures represented by Structural Formulas (1) to (6) is not particularly limited, such polyurethane can be obtained by causing a compound having two functional groups including a hydroxyl group, an amino group, or a glycidyl group to react with polyol and isocyanate, for example.

The polyol is not particularly limited, and it is possible to appropriately select and use one of various polyols known as raw materials of the polyurethane.

For example, it is possible to appropriately select and use one of known polyols such as a polyether polyol or a polyester polyol generally used for manufacturing soft polyurethane foam. One kind of polyol may be used, or two or more kinds thereof may be used in combination.

Note that among the above-described polyols, a polyether polyol is suitably used to manufacture soft polyurethane foam with excellent hygro-thermal durability and high elasticity. For example, polyethylene propylene ether triol, polyethylene propylene ester polyol, or the like is preferably used.

The number average molecular weight of the polyol is preferably 1000 to 10000, is more preferably 1500 to 8000, and is further preferably 2000 to 6000, for example. It is easy to control elasticity of the soft polyurethane foam to an appropriate range and to control elasticity of the foam roller to an appropriate range by the number average molecular weight of the polyol falling within the above-described range. Also, it is possible to use two or more kinds of polyols with different number average molecular weights in combination.

The polyisocyanate can be appropriately selected and used from among various polyisocyanates known as raw materials of the polyurethane.

Examples thereof include 2,4- and 2,6-tolylene diisocyanate (TDI), tolidine diisocyanate (TODI), naphthylene diisocyanate (NDI), xylylene diisocyanate (XDI), 4,4′-diphenylmethane diisocyanate (MDI), carbodiimide-modified MDI, polymethylene polyphenyl polyisocyanate, and polymeric polyisocyanate. The above polyisocyanate may be used alone, or two or more kinds thereof may be used in combination.

Note that an isocyanate group-terminated prepolymer obtained by causing polyisocyanate with one or two or more known active hydrogen compounds can also be used as the polyisocyanate.

The polyisocyanate preferably contains tolylene diisocyanate (TDI) as a main component. Since the TDI structure has only two isocyanate groups, the cationic structure is unlikely to be bound to the polymer chain and migration of the anion attracted to the cationic structure is unlikely to be restricted. Therefore, the anion and the cationic structure are more easily attracted to each other and the above-mentioned formation of the ion aggregate is further promoted, by using the polyisocyanate containing TDI as a main component.

To enhance the mutually attracting effect of the anion and the cationic structure, the polyisocyanate preferably comprises 50% by mass or more of TDI. The content of TDI in the polyisocyanate is more preferably equal to or greater than 70% by mass and is further preferably equal to or greater than 80% by mass.

The polyurethane preferably has at least one TDI structure selected from the group consisting of a structure represented by Structural Formula (11) below and a structure represented by Structural Formula (12) below.

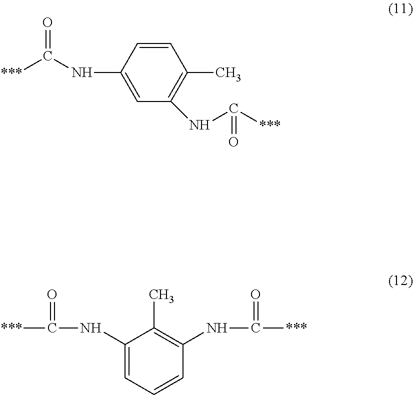

In Structural Formulas (11) and (12), a symbol “***” represents a bonding portion with a nitrogen atom in the Structural Formula (1), a bonding portion with a nitrogen atom or a carbon atom in a nitrogen-containing heterocyclic ring in the Structural Formulas (2) to (6), or a bonding portion with a carbon atom in a polymer chain in the polyurethane.

The anion and the cationic structure are more likely to be attracted, and the above-described ion aggregate is more likely to be formed by the polyurethane having at least one TDI structure selected from the group consisting of the structure represented by Structural Formula (11) above and the structure represented by Structural Formula (12) above. As a result, the shape restoring characteristics of the foam layer can be more easily improved.

The polyol and the polyisocyanate are preferably mixed such that the ratio (molar ratio) of an isocyanate group in the polyisocyanate to a hydroxyl group in the polyol is from 1.0 to 2.0. The mixture ratio within the above-mentioned range is preferable because it is easy to curb remaining of an unreacted component.

### Alkali Metal and Alkaline-Earth Metal

When the sum of the content of alkali metal and alkaline-earth metal in the foam layer which are extracted by immersing the foam layer in acetone is defined as A (mol/g), and the sum of the content of anion in the foam layer which is extracted by immersing the foam layer in acetone is defined as B (mol/g), A/B is 0.0400 or less.

In the present disclosure, the alkali metal refers to, for example, lithium, sodium, potassium, rubidium, cesium, francium, or the like. Also, the alkaline-earth metal refers to, for example, magnesium, calcium, strontium, barium, radium, or the like.

A/B is preferably 0.0300 or less, is more preferably 0.0200 or less, and is further preferably 0.0100 or less. Although the lower limit of A/B is not particularly limited, the lower limit is preferably 0.0010 or more.

In other words, A/B is preferably from 0.0010 to 0.0400, is more preferably from 0.0010 to 0.0300, is further preferably from 0.0010 to 0.0200, and is yet further preferably from 0.0010 to 0.0100.

A/B falling within the above range indicates that the ratio of the content of alkali metal and alkaline-earth metal relative to the total amount of anion in the foam layer is low.

As described above, the alkali metal ion and alkaline-earth metal ion are likely to inhibit the formation of ion bonding between the cation and the anion by electrically attracting the anion with each other. Therefore, the ion aggregate is more likely to be formed, and it is possible to enhance restorability when a depression is generated in the foam layer, by reducing the content of alkali metal and alkaline-earth metal with respect to the amount of anion in the foam layer.

The sum A of the content of alkali metal and alkaline-earth metal in the foam layer is preferably 0.1×10⁻⁷ to 1.0×10⁻⁶ mol/g, is more preferably 0.1×10⁻⁷ to 0.7×10⁻⁶ mol/g, and is further preferably 0.1×10⁻⁷ to 0.5×10⁻⁶ mol/g. The sum B of the content of anion in the foam layer is preferably 1.0×10⁻⁶ to 50.0×10⁻⁶ mol/g, is more preferably 2.0×10⁻⁶ to 45.0×10⁻⁶ mol/g, and is further preferably 3.0×10⁻⁶ to 43.0×10⁻⁶ mol/g.

The content of alkali metal and alkaline-earth metal in the foam layer can be reduced by removing impurities in a process of producing the ion compound. The amount of anion in the foam layer increases in proportion to the amount of the ion compound blended in the above-described polyurethane raw material mixture. In other words, it is possible to control the value of A/B within the above-described range by removing the impurities while increasing the amount of blended ion compound with respect to the polyurethane raw material mixture.

Reasons that the alkali metal and the alkaline-earth metal are mixed into the foam layer include a case where such metal is originally comprised as impurities in the raw materials (for example, the ion compound, polyol, isocyanate, and the like) of the foam layer, a case where such metal is mixed thereinto in a manufacturing process of forming the foam layer, and the like.

For example, a method in which metal comprised in the ion compound is removed is preferably used as a way of controlling the sum of the content of alkali metal and alkaline-earth metal in the foam layer within the above-described range. For example, it is possible to remove the metal in the ion compound by obtaining the ion compound by a neutralization reaction, which will be described later. As another way, the metal in the ion compound can be removed to some extent by causing the ion compound to pass through an ion exchange membrane a plurality of times.

The content of alkali metal and alkaline-earth metal in the ion compound is preferably 8000 ppm or less, is more preferably 6000 ppm or less, and is further preferably 5000 ppm or less.

Since the metal comprised in other materials is not comprised in the ion compound by obtaining the ion compound through a neutralization reaction, for example, it is possible to reduce the amount of alkali metal and alkaline-earth metal comprised as impurities. On the other hand, in the case where the ion compound is obtained by the neutralization reaction, the yield is likely to become low for the reason described later.

According to the investigation made by the present inventors, it has been found to be possible to obtain an ion compound with low content of alkali metal and alkaline-earth metal at a high yield by causing a neutralization reaction between a compound having a precursor of the above-described cationic structure having a hydroxyalkyl group and a hydroxide ion and a compound having an anion and a hydrogen ion at a low concentration for a long period of time.

A solution comprising the precursor of the cationic structure having a hydroxyalkyl group and a compound having a hydroxide ion are strongly basic. In the strongly basic solution, desorption of the hydroxyalkyl group bonded to a nitrogen atom in the structure of the above-described cationic structure precursor and dehydration-condensation with another hydroxyalkyl group are likely to occur, resulting in a low yield. It is known that in a case of a structure in which a hydrogen atom is bonded to the second position of a nitrogen-containing heterocycle in the above-described precursor of the cation, in particular, a part of the strongly basic system may have an N-heterocyclic carbene structure, and the carbene structure does not contribute to the neutralization reaction for obtaining the target object, and the yield is thus likely to become low as a result.

Therefore, it is considered to be difficult in some cases to employ the neutralization reaction as a synthesis method for obtaining a salt of the precursor of the above-described cation having a hydroxyalkyl group from the viewpoint of the yield.

On the other hand, the present inventors have found that the salt of the precursor of the above-described cation having a hydroxyalkyl group can be obtained at a high yield by performing the neutralization reaction at a low concentration for a long period of time.

### Method for Producing Ion Compound

A method for producing the ion compound comprises, for example, the following processes.
Process (1): a process of obtaining a cation salt intermediate 1, which is a cation in ion compounds represented by Formulas (A) to (F), which will be described later
Process (2): a process of obtaining a cation salt intermediate 2 having a hydroxide anion by adding an ion exchange resin to the cation salt intermediate 1 and performing ion exchange
Process (3): a process of causing a neutralization reaction between the cation salt intermediate 2 and a compound having a desired anion (bis(fluorosulfonyl)imide anion and a hydrogen ion)

A method for obtaining the cation salt intermediate 1 in above-described Process (1) is not particularly limited, and it is possible to use a known method.

In above-described Process (2), the cation salt intermediate 1 is dissolved in water or the like, and an ion exchange reaction is performed by adding an ion exchange resin, thereby obtaining the cation salt intermediate 2 having a hydroxide anion. As the ion exchange resin, a known anion exchange resin can be used. After the reaction, the ion exchange resin is filtered, thereby obtaining an aqueous solution of the cation salt intermediate 2.

In above-described Process (3), a neutralization reaction is caused between the cation salt intermediate 2 and the compound having the desired anion and the hydrogen ion. For example, it is preferable to add an anion aqueous solution dropwise to the aqueous solution of the cation salt intermediate 2. As the desired anion, bis(fluorosulfonyl)imide anion is used.

For example, it is preferable to add an aqueous solution of bis(fluorosulfonyl)imide dropwise to the aqueous solution of the cation salt intermediate 2. At this time, the concentration of the aqueous solution of the cation salt intermediate 2 is preferably 0.1 to 10% by mass. The concentration of the aqueous solution of anion is preferably 1 to 30% by mass. It is also preferable to perform the neutralization reaction for 30 minutes to 10 hours.

### Concerning Relationship Between Ion Aggregate and SA/SB

In analysis of the foam layer by the direct sample introduction method using a gas chromatograph mass spectrometer, the temperature of the foam layer is raised to 1000° C. at a temperature rising speed of 8° C./s, and components obtained by decomposing the foam layer are measured. At this time, a chromatogram is drawn by plotting a detection time on the horizontal axis and plotting a detection intensity on the vertical axis.

In the chromatograph, it is preferable that two peaks corresponding to tolylene diisocyanate structure be present. When the peak detected earlier out of the two peaks is defined as a peak A, the peak detected later is defined as a peak B, the area of the peak A is defined as SA, and the area of the peak B is defined as SB, SA and SB preferably satisfy 0.7≤SA/SB≤1.2.

A method for specifying the two peaks corresponding to the TDI structure will be described later.

The present inventors consider that the presence of the two peaks corresponding to tolylene diisocyanate (TDI) indicates the formation of an ion aggregate in the foam layer for the following reason.

In the gas chromatograph (GC) measurement, a component decomposed from a weak bond and gasified is detected as a spectrum. Since the spectrum is detected at the timing at which two urethane bonds are decomposed in TDI, the number of peaks is originally one.

Here, in the foam roller of the present disclosure, the ionic aggregate is formed inside the foam layer, cationic structures are present in a locally concentrated manner, and a urethane bond via TDI and an ion bond via an anion are present between the cationic structures. In a case where such a foam layer is subjected to the gas chromatograph measurement, the ion bond which is a weaker bond than the urethane bond is decomposed earlier, and only the cationic structures remain. It is believed that a repulsive force acts between the remaining cationic structures, and the TDI bonded between the cationic structures becomes unstable and is decomposed at a lower temperature than an original decomposition temperature.

From the above point, it is considered that if the ion aggregate has been formed inside the foam layer, two peaks corresponding to the TDI structure appear in the above-described chromatograph. Also, the present inventors consider that a larger amount of ion aggregate is formed as the spectrum (SA) decomposed at a lower temperature than the original decomposition temperature is larger.

SA/SB falling within the above-described range indicates that SA is greater than SB to some extent. In other words, it indicates that the ion aggregate has sufficiently been formed in the foam layer. It is possible to further enhance restorability of the foam layer and to further enhance the effect of the present disclosure by forming a large amount of ion aggregate.

Examples of a method of increasing SA include a method of reducing the content of alkali metal or alkaline-earth metal in the foam layer and selecting materials such that the anion and the cationic structure strongly attract each other.

SA/SB is more preferably from 0.8 to 1.2, and is further preferably from 0.9 to 1.2. The value of SA is preferably 20 to 70, is more preferably 30 to 60, and is further preferably 40 to 50, for example. The value of SB is preferably 30 to 80, is more preferably 40 to 70, and is further preferably 50 to 60, for example.

### OTHERS

A catalyst, a blowing agent, a foam stabilizer, or other auxiliary agents can be used as needed for the foam layer of the foam roller.

The catalyst is not particularly limited, and a catalyst can be appropriately selected and used from various kinds of known catalysts. For example, amine-based catalysts (triethylenediamine, bis(dimethylaminoethyl) ether, N,N,N′,N′-tetramethylhexanediamine, 1,8-diazabicyclo(5,4,0)undecene-7, 1,5-diazabicyclo(4,3,0)nonene-5, 1,2-dimethylimidazole, N-ethylmorpholine, N-methylmorpholine, and the like), organometallic catalysts (tin octylate, tin oleate, dibutyltin dilaurate, dibutyltin diacetate, tetra-i-propoxytitanium, tetra-n-butoxytitanium, tetrakis(2-ethylhexyloxy)titanium, and the like), and acid salt catalysts obtained by lowering the initial activities of the amine-based catalysts and the organometallic catalysts (carboxylates, formates, octylates, borates, and the like) can be used. One kind of the catalyst may be used, or two or more kinds thereof may be used in combination.

The blowing agent is not particularly limited, and a blowing agent can be appropriately selected from various kinds of known blowing agents and used. In particular, water reacts with the polyisocyanate to generate carbon dioxide gas and is thus suitably used as the blowing agent. In addition, other blowing agents may also be jointly used with water.

The foam stabilizer is not particularly limited, and a foam stabilizer can be appropriately selected from various kinds of known foam stabilizers and used. It is possible to use, for example, a silicone foam stabilizer.

As the other auxiliary agents, a crosslinking agent, a flame retardant, a coloring agent, an ultraviolet absorbent, an antioxidant, a conductive filler, or the like may be used as necessary to an extent that the effect of the present disclosure is not hindered. As the conductive filler, it is possible to use carbon black; and conductive metal such as aluminum and copper. Furthermore, other ion compounds may also be jointly used to an extent that the effect of the present disclosure is not impaired.

When the foam layer is formed, the content of ion compound in the raw material mixture is preferably 0.1 to 30 parts by mass with respect to 100 parts by mass of binder resin forming the foaming conductive elastic layer from the viewpoint of stability. In a case where a plurality of ion compounds are used together, the sum of the content thereof preferably falls within the above-described range.

As described above, the foam roller having the foam layer can be suitably used as a toner supply roller. The toner supply roller is required to have performance of uniformly supplying a toner to the surface of the developing roller, and characteristics such as an average cell diameter, the number of cells, and the air flow amount on the surface, the density of the entire foam layer, and the like are important.

Although physical property values of the foam layer are not particularly limited, the foam layer preferably has values within the numerical ranges as follows, for example. The foam layer preferably has a surface average cell diameter of 100 to 500 μm, for example. The number of cells on the surface of the foam layer is preferably 50 to 300 cells/inch, for example. The air flow amount on the surface of the foam layer is preferably 0.5 to 3.0 L/min, for example.

The average cell diameter and the number of cells can be controlled by, for example, the adjustment of conditions in the fabrication step of the conductive elastic layer or the addition of an auxiliary agent to be described below.

### Method for Producing Foam Roller

A method for producing the foam roller preferably comprises Processes (1) to (4) below.
Process (1): a process of obtaining an ion compound comprising a cation and an anion
Process (2): a process of obtaining foam layer forming materials comprising at least the ion compound, polyol, polyisocyanate, and a blowing agent
Process (3): a process of disposing the substrate in the mold
Process (4): a process of pouring the foam layer forming materials into the mold and foaming and curing the materials, thereby forming the foam layer

### Method for Forming Foam Layer

A method for forming the foam layer is not particularly limited, and the foam layer can be formed by a known method. It is possible to use any method such as a method using a blowing agent, a method of mixing air bubbles through mechanical stirring, or the like. The foaming ratio may be determined as appropriate and is not particularly limited.

It is possible to obtain the foam layer of the foam roller by causing the foam layer forming materials which are a mixture of the following materials, for example, to react while causing the foaming.
1. Materials for forming binder resin
   Polyol (such as polyether polyol)
   Polyisocyanate
2. An ion compound having two functional groups comprising a hydroxyl group, an amino group, or a glycidyl group in a cationic structure
3. Catalyst
4. Foam stabilizer
5. Blowing agent

The foam layer forming materials comprise at least an ion compound, polyol, polyisocyanate, and a blowing agent. The ion compound is preferably any of the ion compounds represented by Formulas (A) to (F) below. The ion compound is preferably obtained by the above-described neutralization reaction.

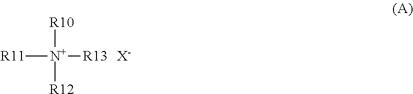

In Formula (A), R10 represents a hydrocarbon group having 1 to 4 carbon atoms. Two of R11 to R13 represent a functional group including a hydroxyl group, an amino group, or a glycidyl group, and the other one represents a hydrogen atom or a hydrocarbon group having 1 to 4 carbon atoms. X⁻ represents an anion.

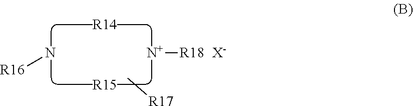

In Formula (B), R14 and R15 represent hydrocarbon groups necessary to form a nitrogen-containing heteroaromatic 5-membered ring together with a nitrogen atom to which each of R14 and R15 is bonded. Two of R16 to R18 represent a functional group including a hydroxyl group, an amino group, or a glycidyl group, and the other one represents a hydrogen atom or a hydrocarbon group having 1 to 4 carbon atoms. X⁻ represents an anion.

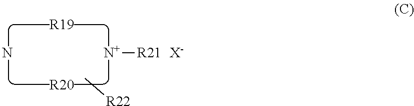

In Formula (C), R19 and R20 represent hydrocarbon groups necessary to form a nitrogen-containing heteroaromatic 6-membered ring together with a nitrogen atom to which each of R19 and R20 is bonded. R21 and R22 represent functional groups including a hydroxyl group, an amino group, or a glycidyl group. X⁻ represents an anion.

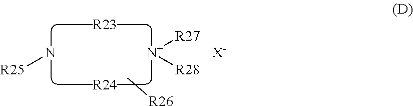

In Formula (D), R23 and R24 represent hydrocarbon groups necessary to form a nitrogen-containing heteroalicyclic group together with a nitrogen atom to which each of R23 and R24 is bonded. Two of R25 to R28 represent functional groups including a hydroxyl group, an amino group, or a glycidyl group, and the other two represent a hydrogen atom or a hydrocarbon group having 1 to 4 carbon atoms. X⁻ represents an anion.

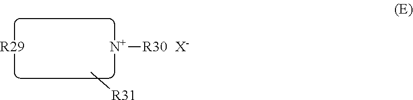

In Formula (E), R29 represents a hydrocarbon group necessary to form a nitrogen-containing aromatic ring together with a nitrogen atom to which R29 is bonded. R30 and R31 represent functional groups including a hydroxyl group, an amino group, or a glycidyl group. X⁻ represents an anion.

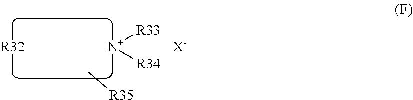

In Formula (F), R32 represents a hydrocarbon group necessary to form a nitrogen-containing heteroalicyclic group together with a nitrogen atom to which R32 is bonded. Two of R33 to R35 represent functional groups including a hydroxyl group, an amino group, or a glycidyl group, and the other one represents a hydrogen atom or a hydrocarbon group having 1 to 4 carbon atoms. X⁻ represents an anion.

The sum of the content of ion compound in the foam layer forming materials preferably falls within the following range from the viewpoint of conductivity and restorability. In other words, the content of ion compound in the foam layer forming materials is preferably 0.1 to 30.0 parts by mass, is more preferably 0.5 to 10.0 parts by mass, and is further preferably 0.6 to 5.0 parts by mass with respect to 100 parts by mass of binder resin.

Although the content of polyol in the foam layer forming materials is not particularly limited, the content of polyol is preferably 50.0 to 90.0 parts by mass, is more preferably 60.0 to 85.0 parts by mass, and is further preferably 70.0 to 80.0 parts by mass, for example.

Although the content of polyisocyanate in the foam layer forming materials is not particularly limited, the content of polyisocyanate is preferably 5.0 to 30.0 parts by mass, is more preferably 7.0 to 25.0 parts by mass, and is further preferably 10.0 to 20.0 parts by mass, for example.

Although the content of blowing agent in the foam layer forming material is not particularly limited, the content of blowing agent is preferably 0.3 to 3.0 parts by mass, is more preferably 0.5 to 2.5 parts by mass, and is further preferably 0.7 to 2.0 parts by mass, for example.

It is possible to form the foam layer by mixing the above-described foam layer forming materials and causing a reaction while foaming them. The temperature and the time for the mixing are not particularly limited. The mixing temperature is normally from 10 to 90° C. and preferably within a range from 20 to 70° C. In addition, the mixing time is normally from one second to 15 minutes and preferably from three seconds to 10 minutes while depending on the structure of a mixing unit to be used, the rotation conditions, or the like.

A method for joining the substrate and the foam layer is not particularly limited. It is possible to use a method in which the substrate is disposed in a mold (mold die) in advance and the raw material mixture as described above is cast and cured, a method in which the raw material mixture is shaped into a predetermined shape, which is to be a foam layer, in advance and is then made to adhere to the substrate, or the like. In any method, it is possible to provide an adhesive layer between the substrate and the foam layer as needed. As this adhesive layer, a known material such as an adhesive or a hot melt sheet can be used.

In the case of the method of casting curing the raw material mixture, a mold releasing agent may be applied to the inner wall of the mold die in advance. The process of disposing the substrate in the mold may further include a process of applying a mold releasing agent to the inner surface of the mold.

As the mold releasing agent, a known mold releasing agent can be used. Examples thereof include water-based mold releasing agents containing a wax component and a silicone oil and mold release agents obtained by dissolving a fluorine resin in a fluorine-based solvent. Examples of a fluororesin-containing mold releasing agent include a fluororesin-containing mold releasing agent (trade name: FLUORO SURF, FG-5093F130-0.5, manufactured by Fluoro Technology Co., LTD.) The mold releasing agent is preferably a wax mainly containing low-molecular-weight saturated hydrocarbon, which will be described later.

A method for forming the shape of the foam layer as the foam roller is not particularly limited. For example, in addition to a method in which the raw material mixture is cast in the mold having a predetermined shape described above or the like, the following methods or the like can be used. Examples of the method include a method in which polyurethane foam in a block state is cut into a predetermined dimension by cutting, a method in which polishing is performed to obtain a predetermined dimension, and a method achieved by appropriately combining these methods.

### Concerning Relationship Between Surface Smoothness and Wax Component

It is possible to further enhance toner supply performance of the foam roller by enhancing smoothness of the surface of the foam layer. More specifically, adhesion to the developing roller can be improved and performance of toner supply to the developing roller can be further enhanced by applying a wax component mainly containing saturated hydrocarbon to the surface of the foam layer.

The foam roller preferably comprises, on the surface of the foam layer, a wax mainly comprising a low-molecular-weight saturated hydrocarbon. The low-molecular-weight saturated hydrocarbon in the present disclosure refers to saturated hydrocarbon with a molecular weight of 300 to 1500. A wax mainly comprising the low-molecular-weight saturated hydrocarbon means that the content of low-molecular-weight saturated hydrocarbon in the wax is equal to or greater than 80% by mass.

Examples of the wax mainly containing the low-molecular-weight saturated hydrocarbon include a wax-based mold releasing agent (trade name: Frelease 600, manufactured by Neos Corporation).

Examples of the method of applying the wax component comprising the low-molecular-weight saturated hydrocarbon as a main component to the surface of the foam roller include, a method of using a material mainly comprising the low-molecular-weight saturated hydrocarbon as a wax component of the mold releasing agent in the above-described casting and curing process, and a method of applying a wax component mainly comprising the low-molecular-weight saturated hydrocarbon to the surface after the formation of the foam layer.

When the ratio (Ms/Mi) of the amount of saturated hydrocarbon component (Ms) present on the surface of the foam layer with respect to the amount of saturated hydrocarbon component (Mi) present inside the foam layer is defined as MA, MA is preferably 1.2 or more.

In the present disclosure, the inside of the foam layer refers to a part of the foam layer except for a region in the vicinity of surface. The region in the vicinity of the surface refers to a region up to 1 mm from the outer surface of the foam layer toward the inner side (substrate side). Mi and Ms can be measured by, for example, a time-of-flight secondary ion mass spectrometry. Details of the measurement method will be described later.

A large value of MA indicates that more wax mainly comprising the low-molecular-weight saturated hydrocarbon is present on the surface of the foam layer than inside the foam layer. In a case where MA is 1.2 or more, it is possible to determine that the wax mainly comprising the low-molecular-weight saturated hydrocarbon is sufficiently present on the surface of the foam layer.

MA is preferably from 1.1 to 2.0, is more preferably from 1.2 to 1.9, and is further preferably from 1.5 to 1.8.

### Electrophotographic Image Forming Apparatus

An electrophotographic image forming apparatus according to another aspect of the present disclosure comprises the above-described foam roller. In other words, the foam roller according to the aspect of the present disclosure can be suitably used as a toner supply roller. The foam roller can be applied to any developing device out of a non-contact-type developing device and a contact-type developing device using a magnetic single-component toner or a non-magnetic single-component toner.

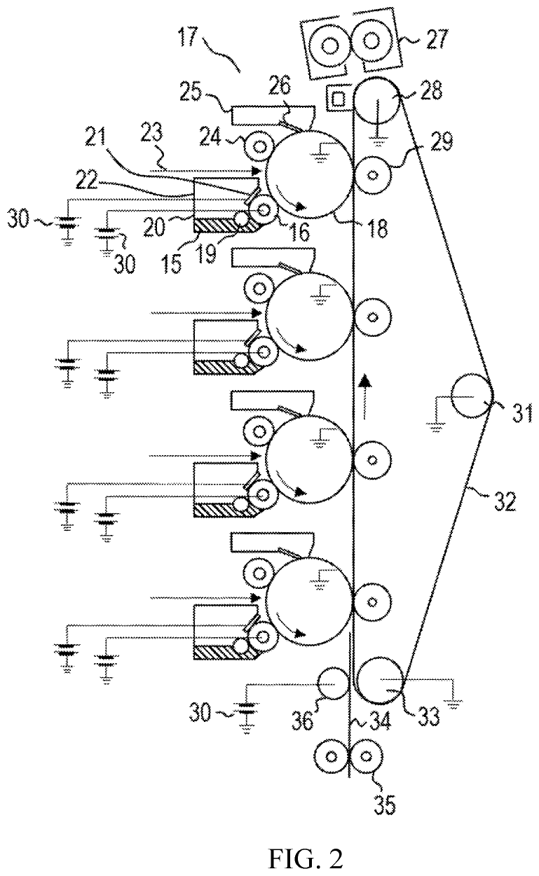

FIG. 2 is a schematic sectional view illustrating an example of the electrophotographic image forming apparatus in which the foam roller is mounted as a toner supply roller for a contact-type developing device using a single-component toner.

A developing device 22 comprises a toner container 20 storing a toner 15 as the single-component toner, a developing roller 16, a developer supply roller 19 that supplies a developer (toner) to the developing roller 16, and a developing blade 21 that regulates the thickness of a toner layer on the developing roller 16. The developing roller 16 is located at an opening extending in the longitudinal direction inside the toner container 20 and is installed in contact with an electrophotographic photosensitive member 18.

Note that the electrophotographic photosensitive member 18, a cleaning blade 26, a waste toner storage container 25, and a charging roller 24 may be disposed in the main body of the electrophotographic image forming apparatus. The developing device 22 is prepared for each of color toners of Black (Bk), cyan (C), magenta (M), and yellow (Y) and can perform color printing.

Hereinafter, a print operation of the electrophotographic image forming apparatus will be described.

The electrophotographic photosensitive member 18 rotates in the arrow direction and is uniformly charged by the charging roller 24 for charging the electrophotographic photosensitive member 18. Next, an electrostatic latent image is formed on the surface of the electrophotographic photosensitive member 18 with laser light 23, which is an exposure means. The electrostatic latent image is visualized (developed) as a toner image with the toner 15 applied from the developing roller 16 disposed in contact with the electrophotographic photosensitive member 18 by the developing device 22. The development is a so-called reversal development in which a toner image is formed on an exposure part.

The toner image formed on the electrophotographic photosensitive member 18 is transferred to paper 34, which is a recording medium, with transfer rollers 29, which are transfer members. The paper 34 is fed into the apparatus via a paper feed roller 35 and an adsorption roller 36, and is conveyed between the electrophotographic photosensitive member 18 and the transfer rollers 29 with an endless belt-like transfer conveyor belt 32. The transfer conveyor belt 32 is operated by a driven roller 33, a driving roller 28, and a tension roller 31. A voltage is applied from a bias power source 30 to the developing roller 16, the developing blade 21, the developer supply roller 19, and the adsorption roller 36.

The paper 34 to which the toner image has been transferred is subjected to a fixing treatment with a fixing apparatus 27 and then ejected to the outside of the apparatus, and the printing operation is finished. Meanwhile, transfer residual toner remaining on the electrophotographic photosensitive member 18 without being transferred is scraped off with the cleaning blade 26, which is a cleaning member for cleaning the surface of the photosensitive member, and stored in the waste toner storage container 25. The cleaned electrophotographic photosensitive member 18 repeats the above-described printing operation.

### Process Cartridge

A process cartridge according to another aspect of the present disclosure comprises above-described foam roller. In particular, the foam roller can be suitably used as the developer supply roller 19 in the process cartridge.

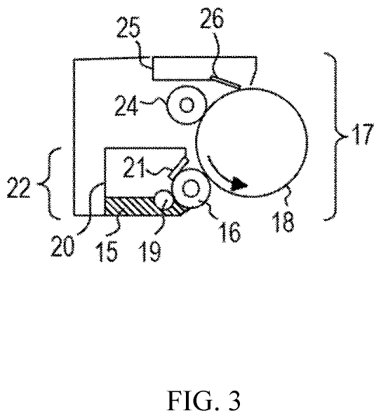

FIG. 3 is a schematic cross-sectional view illustrating one example of the process cartridge. A process cartridge 17 is configured to be attachable to and detachable from the main body of the electrophotographic image forming apparatus. In addition, the developing device 22, the electrophotographic photosensitive member 18, the cleaning blade 26, which is a cleaning means, the waste toner storage container 25, and the charging roller 24, which is a charging means, are integrated in the process cartridge 17.

Here, the developing device 22 comprises the developing roller 16, which is a developing means, and the developing blade 21. The developing device 22 further comprises the toner container 20, and the toner container 20 is filled with the toner 15. The toner 15 in the toner container 20 is supplied to the surface of the developing roller 16 by the developer supply roller 19, and a layer of the toner 15 having a predetermined thickness is formed on the surface of the developing roller 16 by the developing blade 21.

In other words, the developing device 22 preferably comprises at least the developing roller 16 and the developer supply roller 19 that supplies the developer to the developing roller. Furthermore, a configuration in which a voltage can be applied between the developing roller and the developer supply roller is preferably adopted. The developer supply roller 19 is preferably the above-described foam roller.

### Concerning Method of Supplying Toner by Developer Supply Roller

Examples of a method of supplying the toner to the developing roller 16 by the developer supply roller 19 include a mechanical supply method and an electrical supply method.

The mechanical supply method is a method in which the toner is held on the surface layer of the developer supply roller 19 and the toner is supplied through contact with the developing roller 16. At this time, if the surface layer of the developer supply roller 19 is a layer having voids such as a foam layer, the amount of the toner held increases, and it is possible to more efficiently supply the toner. Furthermore, if the surface layer of the developer supply roller 19 is a foam layer, the held toner is pushed out by the foam layer contracting at the time of contact with the developing roller 16, and discharge of the toner from the developer supply roller 19 is prompted.

The electrical supply method uses a biasing force of a charged toner due to a bias potential difference between the bias applied to the developer supply roller 19 and the bias applied to the developing roller 16. Specifically, in a case where the polarity of the bias potential difference is the same polarity as the normal charging polarity of the toner, a biasing force on the developing roller 16 side from the developer supply roller 19 works on the toner at the contact portion. The toner is supplied in this manner.

The process cartridge preferably has a contact member which is electrically connected to an electric contact of the main body when the process cartridge is mounted on the main body of the electrophotographic image forming apparatus. The process cartridge comprises a developing roller, and a developer supply roller for supplying a developer to the developing roller, and is preferably configured to apply a voltage between the developing roller and the developer supply roller through electrical connection to the main body. The developer supply roller is preferably the above-described foam roller.

Hereinafter, a method of measuring physical properties of the foam roller will be described.

### Apparent Density

The volume of the foam layer of the foam roller is calculated, and the mass of the foam layer is measured. The apparent density can be obtained by dividing the mass of the foam layer by the volume of the foam layer.

### Method of Measuring A/B

### (1) Method for Evaluating Sum of Content of Alkali Metal and Alkaline-Earth Metal in Foam Layer

The sum of the content of alkali metal and alkaline-earth metal in the foam layer is measured as follows.

0.5 g of foam layer is immersed in 5 ml of acetone, the alkali metal and the alkaline-earth metal are extracted, and then the acetone is evaporated to dryness. A sample prepared by dissolving the extract in 5 ml of ultrapure water is used. Alternatively, an ion compound can also be used as a sample. In a case where the ion compound is used as a sample, the sample can be obtained in the same manner as described above other than that 0.01 g of ion compound is dipped in 10 ml of acetone.

The sample is measured by ion chromatography, and the content of alkali metal and alkaline-earth metal is calculated from the spectrum amounts of alkali metal and alkaline-earth metal.

The measurement conditions for ion chromatograph are as follows.
Apparatus: Integrion RFiC (manufactured by Thermo)
Standard solution: Multication Standard Solution-II (manufactured by Kanto Chemical Co., Ltd.)
Column: CS-16 (manufactured by Thermo)
Column temperature: 40° C. (cation)
Mobile phase: 30 mM aqueous solution of methanesulfonic acid
Flow rate: 0.36 mL/min
Detector: Electrical conductivity
Injection amount: 10 μL
Analysis time: 27 minutes

In addition, the following standard solutions 1 to 3 are prepared as multiple standard samples of alkali metal and alkaline-earth metal, and calibration curves of the alkali metal and the alkaline-earth metal are created by performing measurement under the above-described conditions.
Standard solution 1—Standard solution described above
Standard solution 2—the above-described standard solution is diluted with ultrapure water such that the concentration is 0.50% by mass
Standard solution 3—the above-described standard solution is diluted with ultrapure water such that the concentration is 0.20% by mass

The content of alkali metal and alkaline-earth metal in the sample is obtained from the created calibration curve.

Each obtained content of alkali metal and alkaline-earth metal is divided by the amount of each element and is dealt as a molar mass of the alkali metal and the alkaline-earth metal comprised in the foam layer.

The obtained sum of the content of alkali metal and alkaline-earth metal is defined as a sum A (mol/g) of the content of alkali metal and alkaline-earth metal in the foam layer.

A (mol/g) is the number of moles of alkali metal and alkaline-earth metal per unit mass in the foam layer.

### (2) Method for Evaluating Sum of Content of Anion in Foam Layer

The sum of the amount of anion in the foam layer is measured as follows.

2 g of the foam layer is immersed in 10 ml of acetone to extract anion, and the acetone is then evaporated to dryness. The resulting product is dissolved in 10 ml of acetonitrile and is then filtered with a 0.2 μm filter. The filtered liquid is subjected to liquid chromatography mass spectrometry to calculate the content of anion from the peak area.

Measurement conditions for the liquid chromatography mass spectrometry are as follows.
Apparatus: Ultimate 3000/LCQ FLEET (manufactured by Thermo)

### (HPLC Conditions)

Column: Acclaim Trinity P1 3 μm, 2.1×100 mm (manufactured by Thermo)
(Mixed mode of a reversed phase (RP), strong cation exchange (SCX), weak anion exchange (wax))
Column temperature: 30° C.
Mobile phase: A: acetonitrile, B: 100 mM aqueous solution of ammonium formate (pH 5.0), C: Pure water; and
A/B/C=70/1/29
Flow rate: 0.5 mL/min
Detector: Corona Veo (Corona CAD), PDA (190 nm to 800 nm)
Injection amount: 10 μL
Analysis Time: 10 minutes

### (MS Conditions)

MS ionization: ESI positive/negative
Scan Ranges: m/z 50 to 1000

A standard sample of the anion is measured, and a calibration curve is created by the following method.

### Method of Creating a Calibration Line

10 mg of compound containing a bis(fluorosulfonyl)imide anion (for example, lithium bis(fluorosulfonyl)imide) is dissolved in 2 mL of acetonitrile to prepare a 5000 μg/mL of solution. The obtained solution is diluted with acetonitrile to prepare solutions of various concentrations, and a sample obtained by filtering 1.5 mL of the solution with a 0.2 μm filter is obtained as a standard sample. Measurement is performed under the above-described conditions using the obtained standard sample, and a calibration curve is created.

The content of anion in the sample is obtained from the created calibration curve.

Also, the content of anion thus obtained is divided by the amount of each element and is treated as a molar mass of the anion contained in the foam layer. The obtained sum of the content of anion is defined as a sum B (mol/g) of the content of anion in the foam layer.

B (mol/g) is the number of moles of anions per unit mass in the foam layer.

The obtained sum A (mol/g) of the content of alkali metal and alkaline-earth metal in the foam layer is divided by the sum B (mol/g) of the content of anion in the foam layer to obtain the content (A/B) of the alkali metal and alkaline-earth metal with respect to the amount of anion comprised in the foam layer.

### Measurement of SA/SB

Analysis is performed using a direct sample introduction method (DI method) in which the sample is introduced directly to an ion source without causing it to pass through a gas chromatograph (GC), and SA/SB is calculated by the procedure described below.

As apparatuses, an ion-trapping-type GC/MS (trade name: Polaris Q, manufactured by Thermo Fisher Scientific) is used, and a direct exposure probe (DEP) is used as a direct introduction probe.

The foam roller is measured by the following method. Note that in the sampling, the foam layer of the foam roller is cut off with a microscale. Specifically, the foam layer is cut into a size with a width of 1 mm×a height of 1 mm×and a thickness of 1 mm such that the surface of the foam layer is included.

0.1 μg of sample sampled from the surface of the foam layer is fixed to a filament located at the tip of the probe and is then inserted directly into an ionization chamber. Thereafter, the sample is quickly heated from room temperature up to 1000° C. at a constant temperature rising speed (8° C./s), and the vaporized gas is detected by a mass spectrometer. A chromatogram is depicted by plotting the detection time on the horizontal axis and plotting the detection intensity of the component obtained by the decomposition of the foam layer on the vertical axis.

In a case where two peaks are detected in the extracted ion thermogram corresponding to the range of the m/z value (173.5 to 174.5) corresponding to the TDI structures of Structural Formulas (11) and (12), it is determined that there are two peaks corresponding to the TDI structure. The peak detected earlier out of the two detected peaks is defined as a peak A, and the peak detected later is defined as a peak B. The integrated intensity of the peak A is defined as SA, and the integrated intensity of the peak B is defined as SB, (SA/SB) is calculated using the values of SA and SB.

### Surface Component Analysis

The presence or absence of the wax mainly containing the low-molecular-weight saturated hydrocarbon on the surface of the foam layer can be checked by comparing the amounts of saturated hydrocarbon component present on the surface of the foam layer and inside the foam layer.

The ratio between the surface and the inside of the saturated hydrocarbon component (the ratio of the amount of saturated hydrocarbon component present on the surface of the foam layer to the amount of saturated hydrocarbon component inside the foam layer) is measured as follows.

A time-of-flight secondary ion mass spectrometry was performed on each of the outer surface of the foam layer and the inside of the foam layer. For the inside of the foam layer, a region exposed by cutting a region up to 1 mm from the outer surface of the foam layer toward the inner side (substrate side) is defined as a measurement region.

Values obtained by dividing m/z values (54.5 to 55.5, 56.5 to 57.5, and 68.5 to 69.5) at representative three points corresponding to the molecular weight of low-molecular-weight saturated hydrocarbon by an m/z value (58.5 to 59.5) corresponding to propylene glycol (PPG) are defined as M1, M2, and M3 corresponding to parts of the amount of saturated hydrocarbon component present on the surface of the foam layer, respectively. In other words, each of M1, M2, and M3 is as follows.

M1={m/z value(54.5 to 55.5)}/{m/z value(58.5 to 59.5)}

M2={m/z value(56.5 to 57.5)}/{m/z value(58.5 to 59.5)}

M3={m/z value(68.5 to 69.5)}/{m/z value(58.5 to 59.5)}

Analysis is carried out on each of the outer surface of the foam layer and the above-mentioned measurement region inside the foam layer to obtain M1, M2, and M3. M1, M2 and M3 on the surface of the foam layer are defined as M1s, M2s, and M3s, and M1, M2, and M3 inside the foam layer are defined as M1i, M2i, and M3i. An arithmetic mean value MA of M1s/M1i, M2s/M2i, and M3s/M3i is calculated as represented by the expression below.

MA={(M1s/M1i)+(M2s/M2i)+(M3s/M3i)}/3

The larger value of MA indicates that more wax component mainly containing the low-molecular-weight saturated hydrocarbon is present on the surface of the foam layer than inside the foam layer. In the present disclosure, it is determined that the wax component mainly comprising the low-molecular-weight saturated hydrocarbon is comprised on the surface of the foam layer in a case where MA is equal to or greater than 1.2.

### EXAMPLES

The present disclosure will be further described in detail below by way of Examples, but these are not intended to limit the present invention in any way.

### Synthesis of Ion Compound

Ion compounds which were raw materials of polyurethane comprised in foam layers of foam rollers were synthesized.

### Ion Compound I-1

25.4 g of bis(2-hydroxyethyl)dimethylammonium chloride (manufactured by Tokyo Chemical Industry Co., Ltd.) were dissolved in 80.0 g of ion exchange water. The obtained product was dissolved in 160 g of water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-1 in Example 1.

The ion compound I-1 is a compound represented by Formula (I-1) below. Physical properties of the ion compound I-1 are shown in Table 1-1.

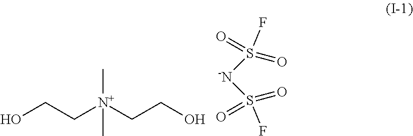

### Ion Compound I-2

15.5 g of diethylenetriamine (manufactured by Tokyo Chemical Industry Co., Ltd.) was dispersed in 35.0 g of tetrahydrofuran. Next, the reaction system was put into a nitrogen atmosphere and was cooled with ice. Subsequently, 45.5 g of methyl iodide (Tokyo Chemical Industry Co., Ltd.) dissolved in 80.0 g of tetrahydrofuran was added dropwise for 30 minutes. The reaction solution was heated under reflux for 12 hours, 100 ml of water was added thereto, and a solvent was distilled off under a reduced pressure. 100 ml of ethanol was added to the residue, the mixture was stirred at room temperature, impurities were removed through celite filtration, and the solvent was distilled off again under a reduced pressure. The thus obtained product was distilled in 160 ml of pure water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-2 in Example 1.

The ion compound I-2 is a compound represented by Formula (I-2) below. Physical properties of the ion compound I-2 are shown in Table 1-1.

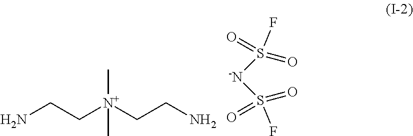

### Ion Compound I-3

A stirring bar and 60 ml of tetrahydrofuran (THF, manufactured by Kanto Chemical Co., Inc.) were charged into an eggplant flask equipped with a Dimroth condenser, 24.0 g of sodium hydride (60% by mass, dispersed in liquid paraffin, manufactured by Tokyo Chemical Industry Co., Ltd.) was dispersed, and the eggplant flask was cooled in an ice bath. A solution of 10.2 g of imidazole (manufactured by Tokyo Chemical Industry Co., Ltd.) dissolved in 60 ml of THF was slowly added dropwise, the ice bath was then removed, and the mixture was stirred at room temperature for two hours. 47.6 g of 2-bromoethanol (manufactured by Tokyo Chemical Industry Co., Ltd.) was added thereto at room temperature, and the mixture was then heated under reflux at 70° C. for seven hours. The reaction liquid after the reaction was filtered, an insoluble content was washed off with THF, and the solvent of the obtained filtrate was distilled off under a reduced pressure. The thus obtained product was dissolved in 590.5 g of water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-3 in Example 1.

The ion compound I-3 is a compound represented by Formula (I-3) below. Physical properties of the ion compound I-3 are shown in Table 1-1.

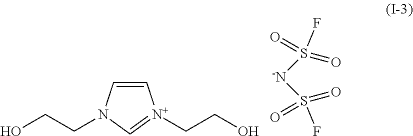

### Ion Compound I-4

A stirring bar and 65 ml of tetrahydrofuran (THF, manufactured by Kanto Chemical Co., Inc.) were charged into an eggplant flask equipped with a Dimroth condenser, 13.5 g of sodium hydride (60% by mass, dispersed in liquid paraffin, manufactured by Tokyo Chemical Industry Co., Ltd.) was dispersed, and the eggplant flask was cooled in an ice bath. A solution of 18.6 g of 5-methylpyrazine-2-methanol (manufactured by Fujifilm Wako Pure Chemical Corporation) dissolved in 60 ml of THF was slowly added dropwise, the ice bath was then removed, and the mixture was stirred at room temperature for two hours. 47.6 g of 2-bromoethanol (manufactured by Tokyo Chemical Industry Co., Ltd.) was added thereto at room temperature, and the mixture was then heated under reflux at 70° C. for seven hours. A reaction liquid after the reaction was filtered, an insoluble content was washed off with THE, and the solvent of the obtained filtrate was distilled off under a reduced pressure. The obtained product was dissolved in 590.5 g of water, 179.3 g of ion exchange resin DOWEX 550A OH (manufactured by DuPont) was added thereto, and the mixture was stirred at room temperature for 1 hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-4 in Example 1.

The ion compound I-4 is a compound represented by Formula (I-4) below. Physical properties of the ion compound I-4 are shown in Table 1-1.

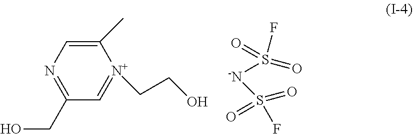

### Ion Compound I-5

A stirring bar and 80 ml of tetrahydrofuran (THF, manufactured by Kanto Chemical Co., Inc.) were charged into an eggplant flask equipped with a Dimroth condenser, 9.2 g of sodium hydride (60% by mass, dispersed in liquid paraffin, manufactured by Tokyo Chemical Industry Co., Ltd.) was dispersed, and the eggplant flask was cooled in an ice bath. A solution of 26.1 g of N,N′-bis-(2-hydroxyethyl)-2,5-dimethylpiperazine (manufactured by Sigma-Aldrich Co., LLC) dissolved in 60 ml of THF was slowly added dropwise, the ice bath was then removed, and the mixture was stirred at room temperature for two hours. 47.6 g of 2-bromoethanol (manufactured by Tokyo Chemical Industry Co., Ltd.) was added thereto at room temperature and then heated under reflux at 70° C. for seven hours. A reaction liquid after the reaction was filtered, an insoluble matter was washed off with THE, and the solvent of the resultant filtrate was distilled off under a reduced pressure. The resultant product was dissolved in 590.5 g of water, 179.3 g of ion exchange resin DOWEX 550A OH (manufactured by DuPont) was added thereto, and the mixture was stirred at room temperature for 1 hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-5 in Example 1.

The ion compound I-5 is a compound represented by Formula (I-5) below. Physical properties of the ion compound I-5 are shown in Table 1-1.

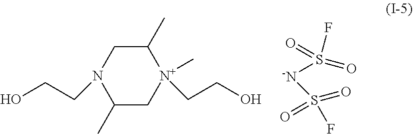

### Ion Compound I-6

22.7 g of 4-pyridine butanol (manufactured by Sigma-Aldrich Co., LLC) was dissolved in 45.0 g of acetonitrile, 23.0 g of 4-bromo-1-butanol (manufactured by Tokyo Chemical Industry Co., Ltd.) was added dropwise at room temperature for 30 minutes, and the mixture was heated under reflux at 90° C. for 12 hours. Then, the reaction solution was cooled to room temperature, and acetonitrile was distilled off under a reduced pressure. The thus obtained concentrate was washed with 30.0 g of diethyl ether, and the supernatant was remove by a separating solution. The washing and the separating operation were repeated three times to thereby obtain a residue. Furthermore, the obtained residue was dissolved in 110.0 g of dichloromethane, was then dissolved in 40.0 g of ion exchange water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-6 in Example 1.

The ion compound I-6 is a compound represented by Formula (I-6) below. Physical properties of the ion compound I-6 are shown in Table 1-2.

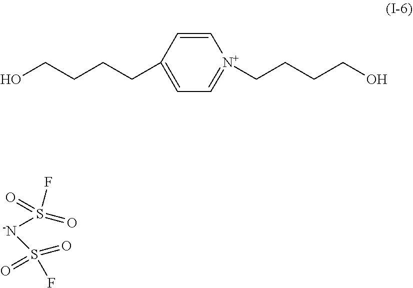

### Ion Compound I-7

A stirring bar and 65 ml of tetrahydrofuran (THF, manufactured by Kanto Chemical Co., Inc.) were charged into an eggplant flask equipped with a Dimroth condenser, 13.5 g of sodium hydride (60% by mass, dispersed in liquid paraffin, manufactured by Tokyo Chemical Industry Co., Ltd.) was dispersed, and the eggplant flask was cooled in an ice bath. A solution of 19.38 g of 2-(2-hydroxyethyl)-1-methylpyrrolidin (manufactured by Tokyo Chemical Industry Co., Ltd.) dissolved in 60 ml of THF was slowly added dropwise, the ice bath was then removed, and the mixture was stirred at room temperature for two hours. 47.6 g of 2-bromoethanol (manufactured by Tokyo Chemical Industry Co., Ltd.) was added thereto at room temperature, and the mixture was then heated under reflux at 70° C. for seven hours. A reaction liquid after the reaction was filtered, an insoluble content was washed off with THE, and the solvent of the obtained filtrate was distilled off under a reduced pressure. The obtained product was dissolved in 590.5 g of water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition I-7 in Example 1.

The ion compound I-7 is a compound represented by Formula (I-7) below. Physical properties of the ion compound I-7 are shown in Table 1-2.

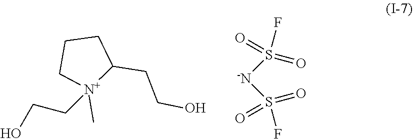

### Ion Compound I-8

An ion compound I-8 was obtained in a manner similar to the synthesis of the ion compound I-3 other than that anion raw materials and the blending amounts thereof were changed as described in Table 1-2. Physical properties of the ion compound I-8 are shown in Table 1-2.

### Ion Compound I-9

15.0 g of 2-methylimidazole-1-ethanol (manufactured by Sigma-Aldrich CO. LLC) and 9.2 g of sodium hydride (60% by mass, dispersed in liquid paraffin) (manufactured by Tokyo Chemical Industry Co., Ltd.) were dissolved in 80.0 g of tetrahydrofuran. 14.5 g of ethyl iodide (manufactured by Showa Chemical Industry Co., Ltd.) dissolved in 80.0 g of tetrahydrofuran was added dropwise thereto at room temperature for 30 minutes, and the mixture was then heated under reflux at 85° C. for 12 hours.

Next, 100 ml of water was added to a reaction solution, and the solvent was distilled off under a reduced pressure. 200 ml of ethanol was added to a residue and stirred at room temperature, an insoluble material was removed by celite filtration, and the solvent was then distilled off again under a reduced pressure.

The obtained product was dissolved in 100 ml of pure water, 38.2 g of anion exchange reagent (hereinafter, referred to as an “anion raw material”) was added thereto, and the mixture was stirred at room temperature for one hour. As the anion raw material, lithium N,N-bis(trifluoromethanesulfonyl)imide (trade name: EF-N115, manufactured by Mitsubishi Materials Electronic Chemicals Co., Ltd.) was used. 100 ml of ethyl acetate was added to a reaction solution, and an organic layer was washed using 80 g of ion exchange water three times.

Next, ethyl acetate was distilled off under a reduced pressure, thereby obtaining an ion compound I-9. The ion compound I-9 is a compound represented by a combination of a structural formula representing the structure corresponding to the ion compound described in Table 1-2 and an anion. Physical properties of the ion compound I-9 are shown in Table 1-2.

### Ion Compound I-10

An ion compound I-10 was obtained in a manner similar to the synthesis of the ion compound I-8 other than that anion raw materials and the blending amounts thereof were changed as described in Table 1-2. Physical properties of the ion compound I-10 are shown in Table 1-2.

### Ion Compound I-11

15.0 g of (1H-imidazole-2-yl)-ethanol (manufactured by Sigma-Aldrich CO. LLC) and 9.2 g of sodium hydride (60% by mass, dispersed in liquid paraffin (manufactured by Tokyo Chemical Industry Co., Ltd.)) were dissolved in 60.0 g of tetrahydrofuran in a nitrogen atmosphere.

42.1 g of 2-bromoethanol (manufactured by Tokyo Chemical Industry Co., Ltd.) dissolved in 80.0 g of tetrahydrofuran was added dropwise thereto at room temperature for 30 minutes, and the mixture was heated under reflux at 85° C. for 12 hours. Next, 100 ml of water was added to a reaction solution, and the solvent was distilled off under a reduced pressure. 200 ml of ethanol was added to a residue and stirred at room temperature, an insoluble material was removed by celite filtration, and the solvent was then distilled off again under a reduced pressure.

The thus obtained product was dissolved in 200 ml of pure water, and an aqueous solution obtained by dissolving 27.2 g of imidodisulfurylfluoride lithium (manufactured by Aaron Chemicals) in 379.6 g of water was added dropwise as an anion raw material for two hours. Note that during the dropwise addition, pH was checked at the same time, and the dropwise addition was stopped at pH 6.3. The solvent of the obtained aqueous solution was distilled off under a reduced pressure, thereby obtaining an ion compound I-11.

The ion compound I-11 is a compound represented by Formula (I-11) below.

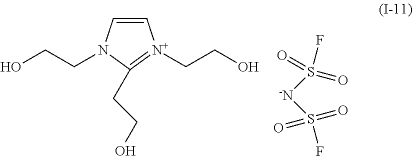

### Ion Compound I-12

15.0 g of 2-(2-methyl-1H imidazol-1-yl) ethanol (manufactured by Sigma-Aldrich CO. LLC) and 9.2 g of sodium hydride (60% by mass, dispersed in liquid paraffin) (manufactured by Tokyo Chemical Industry Co., Ltd.) were dissolved in 80.0 g of tetrahydrofuran. 14.5 g of ethyl iodide (manufactured by Showa Chemical Industry Co., Ltd.) dissolved in 80.0 g of tetrahydrofuran was added dropwise thereto at room temperature for 30 minutes, and the mixture was heated under reflux at 85° C. for 12 hours. Next, 100 ml of water was added to a reaction solution, and the solvent was distilled off under a reduced pressure. 200 ml of ethanol was added to a residue and stirred at room temperature, an insoluble material was removed by celite filtration, and the solvent was then distilled off again under a reduced pressure.

The obtained product was dissolved in 100 ml of pure water, and an aqueous solution obtained by dissolving 27.2 g of imidodisulfurylfluoride lithium (manufactured by Aaron Chemicals) in 379.6 g of water was added dropwise as an anion raw material for two hours. Note that during the dropwise addition, pH was checked at the same time, and the dropwise addition was stopped at pH 6.3. The solvent of the obtained aqueous solution was distilled off under a reduced pressure, thereby obtaining an ion compound I-12.

The ion compound I-12 is a compound represented by Formula (I-12) below.

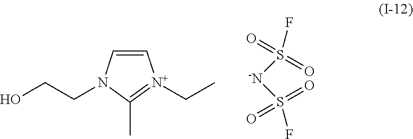

TABLE 1-1

| | | | Structural formula | R in | | | | |
|---|---|---|---|---|---|---|---|---|
| Ion | | Mass | representing | structural | | | | |
| compound | Anion raw material | (g) | cationic structure | formula | Z in structural formula | | | |
| I-1 | Imidodisulfurylfluoride Lithium | 27.2 | Structural Formula | —CH₃ | Z1 | Z2 | Z3 | |
| | (Manufactured by Aaron Chemicals) | | (1) | R1 | Z101 R101: —C₂H₄— | —CH₃ | Z101 R101: —C₂H₄— | |
| I-2 | Imidodisulfurylfluoride Lithium | 27.2 | Structural Formula | —CH₃ | Z1 | Z2 | Z3 | |
| | (Manufactured by Aaron | | (1) | R1 | Z102 | —CH₃ | Z102 | |
| | Chemicals) | | | | R102: | | R102: | |
| | | | | | —C₂H₄— | | —C₂H₄— | |
| I-3 | Imidodisulfurylfluoride Lithium (Manufactured by Aaron Chemicals) | 27.2 | Structural Formulas (2), (7) | 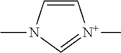 | Z4 Z101 R101: —C₂H₄— | Z5 Z101 R101: —C₂H₄— | Z6 | |
| | | | | R2, R3 | | | | |
| I-4 | Imidodisulfurylfluoride Lithium (Manufactured by Aaron Chemicals) | 27.2 | Structural Formula (3) | 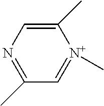 | Z7 Z101 R101; —C₂H₄— | Z8 Z101 R101: —C₂H₄— | Z8 —CH₃ | |
| | | | | R4, R5 | | | | |
| I-5 | Imidodisulfurylfluoride Lithium (Manufactured by Aaron Chemicals) | 27.2 | Structural Formulas (4), (8) | 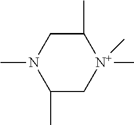 | Z9 Z101 R101: —C₂H₄— | Z10 —CH₃ | Z11 Z101 R101: —C₂H₄— | Z12 —CH₃ |
| | | | | R6, R7 | | | | |

| Ion | d in structural | | Content of alkali metal end alkaline-earth metal (ppm) | | | |
|---|---|---|---|---|---|---|
| compound | formula | Name of anion | Lithium | Sodium | Potassium | Total |
| I-1 | | Bis(fluorosulfonyl)imide anion | 0.1 or less | 4500 | 0.1 or less | 4500 |
| I-2 | | Bis(fluorosulfonyl)imide anion | 0.1 or less | 4500 | 0.1 or less | 4500 |
| I-3 | d1 = 0 | Bis(fluorosulfonyl)imide anion | 0.1 or less | 4500 | 0.1 or less | 4500 |
| I-4 | d2 = 2 | Bis(fluorosulfonyl)imide anion | 0.1 or less | 4500 | 0.1 or less | 4500 |
| I-5 | d3 = 2 | Bis(fluorosulfonyl)imide anion | 0.1 or less | 4500 | 0.1 or less | 4500 |

TABLE 1-2

| | | | Structural formula | | | | |
|---|---|---|---|---|---|---|---|
| Ion | | Mass | representing | R in structural | | | |
| compound | Anion raw material | (g) | cationic structure | formula | Z in structural formula | | |
| I-6 | Imidodisulfurylfluoride Lithium (Manufactured by Aaron Chemicals) | 27.2 | Structural Formulas (5), (9) | 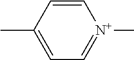 | Z13 Z101 R101: —C₄H₆— | Z14 Z101 R101: —C₄H₆— | |
| | | | | R8 | | | |
| I-7 | Imidodisulfurylfluoride Lithium (Manufactured by Aaron Chemicals) | 27.2 | Structural Formulas (6), (10) | 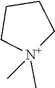 | Z15 —CH₃ | Z16 Z101 R101: —C₂H₄— | Z17 Z101 R101: —C₂H₄— |
| | | | | R9 | | | |
| I-8 | Bis(trifluoromethanesulfonyl)imide (Manufactured by Tokyo Chemical Industry Co., Ltd.) | 42.2 | Structural Formulas (2), (7) | 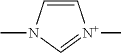 | Z4 Z101 R101: —C₂H₄— | Z5 Z101 R101: —C₂H₄— | Z6 |
| | | | | R2, R3 | | | |
| I-9 | Lithium N,N-bis(fluorosulfonylimide) (Manufactured by Mitsubishi Materials Electronic Chemicals Co., Ltd.) | 27.2 | Structural Formulas (2), (7) | 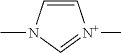 | Z4 Z101 R101: —C₂H₄— | Z5 Z101 R101: —C₂H₄— | |
| | | | | R2, R3 | | | |
| I-10 | Potassium N,N-bis(fluorosulfonylimide) (Manufactured by Mitsubishi Materials Electronic Chemicals Co., Ltd.) | 27.2 | Structural Formulas (2), (7) | 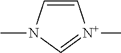 | Z4 Z101 R101: —C₂H₄— | Z5 Z101 R101: —C₂H₄— | Z6 |
| | | | | R2, R3 | | | |

| | | | Content of alkali metal and alkaline-earth | | | |
|---|---|---|---|---|---|---|
| Ion | d in structural | | metal (ppm) | | | |
| compound | formula | Name of anion | Lithium | Sodium | Potassium | Total |
| I-6 | d4 = 1 | Bis(fluorosulfonyl)imide anion | 0.1 or less | 4500 | 0.1 or less | 4500 |
| I-7 | d5 = 1 | Bis(fluorosulfonyl)imide anion | 0.1 or less | 4500 | 0.1 or less | 4500 |
| I-8 | d1 = 0 | Bis(trifluoromethanesulfonyl) | 0.1 or less | 5000 | 0.1 or less | 5000 |
| | | imide anion | | | | |
| I-9 | d1 = 1 | Bis(fluorosulfonyl)imide anion | 26000 | 5000 | 0.1 or less | 31000 |
| I-10 | d1 = 0 | Bis(fluorosulfonyl)imide anion | 0.1 or less | 5000 | 56000 | 62000 |

### Foam Roller

### Production of Foam Roller 1

A core metal having an outer diameter of 5 mm and made of stainless steel (SUS304) as a base substrate was arranged in a mold including a cylindrical member with an inner diameter of 16.5 mm, an upper piece member, and a lower piece member. Note that a water-based releasing agent obtained by dispersing a wax-based mold releasing agent “Frelease 600” (trade name: manufactured by Neos Corporation) in ion exchange water and having a solid content of 3% by mass was applied to the inner surface of the mold die in advance.

The following materials (A), (B), (C), and (E) to (I) were blended, and 2.4 g of urethane composition obtained by the blended materials was poured into a cavity formed in the mold.
(A): Ion compound I-1:5.0 parts by mass
(B): Polyol A (polyethylene propylene ether triol with a number average molecular weight of 2000, trade name: ACTCOL EP-550N; manufactured by Mitsui Chemicals, Inc.): 60.0 parts by mass
(C) Polyol B (polyethylene propylene ether triol with a number average molecular weight of 6000, trade name: ACTCOL EP-950P; manufactured by Mitsui Chemicals, Inc.) 40.0 parts by mass
(E) Polyisocyanate admixture (containing NCO %=45, TDI=80%, and MDI=20%, trade name: COSMONATE™ 20; manufactured by Mitsui Chemicals, Inc.): 24.4 parts by mass
(F): Silicone foam stabilizer (trade name: SRX274C, manufactured by Dow Corning Toray Co., Ltd.): 1.0 parts by mass
(G): Tertiary amine catalyst A (a mixture of bis(2-dimethylaminoethyl)ether and dipropylene glycol, trade name: TOYOCAT-ET, manufactured by Tosoh Corporation): 0.3 parts by mass
(H): Tertiary amine catalyst B (mixture of triethylenediamine and dipropylene glycol, trade name: TEDA-L33, manufactured by Tosoh Corporation): 0.2 parts by mass
(I): Blowing agent (water): 1.4 parts by mass

Subsequently, the mold was heated to 70° C., a urethane rubber composition was foamed and cured for 10 minutes, and a substrate with a foam layer formed on the peripheral surface was released from the mold. Thus, the foam roller 1 comprising a foam layer with a diameter of 16.5 mm on the outer periphery of the substrate was created. Physical properties of the foam roller 1 are shown in Table 2.

### Production of Foam Rollers 2 to 11 and Production of Comparative Foam Rollers 1, 3, 5, and 6

Foam rollers 2 to 11 and comparative foam rollers 1, 3, 5, and 6 were produced similarly to the foam roller 1 other than that the amount of materials poured into the cavity was changed as shown in Table 2 in accordance with the types and the blending amounts of ion compounds, the blending amounts of polyol A and polyol B, and the apparent density. Physical properties of the foam rollers 2 to 11 and comparative foam rollers 1, 3, 5, and 6 are shown in Table 2.

### Production of Foam Roller 12

A foam roller 12 was produced similarly to the foam roller 1 other than that the type and the blending amount of ion compound and the blending amounts of polyol A and polyol B were changed as shown in Table 2, the amount of materials to be poured into the cavity was changed to 0.6 g in accordance with the apparent density, and the polyisocyanate admixture E was changed to (containing NCO %=40, TDI=50%, and MDI=50%, (trade name: COSMONATE™ 50, manufactured by Mitsui Chemicals, Inc.). Physical properties of the foam roller 12 are shown in Table 2.

### Production of Foam Roller 14

A foam roller 14 was produced similarly to the foam roller 1 other than that the amount of materials to be poured into the cavity was changed as shown in Table 2 in accordance with the type and the blending amount of ion compound, the blending amounts of polyol A and polyol B, and the apparent density, the polyisocyanate admixture E was changed to (containing NCO %=40, TDI=50%, and MDI=50%, (trade name: COSMONATE™ 50, manufactured by Mitsui Chemicals, Inc.), and the mold releasing agent was not applied to the inner surface of the mold. Physical properties of the foam roller 14 are shown in Table 2.

### Production of Foam Roller 13 and Comparative Foam Rollers 2 and 4

A foam roller 13 and comparative foam rollers 2 and 4 were produced similarly to the foam roller 1 other than that the amounts of materials to be poured into the cavity were changed as shown in Table 2 in accordance with the types and the blending amounts of ion compounds, the blending amounts of polyol A and polyol B, and the apparent densities and the mold releasing agent was not applied to the inner surface of the mold. Physical properties of the foam roller 13 and the comparative foam rollers 2 and 4 are shown in Table 2.

TABLE 2

| | | | | | Amount of | | | | | | | | |
|---|---|---|---|---|---|---|---|---|---|---|---|---|---|
| | Ion | | | | material to be | Apparent | | | | | | | |
| | compound I | | Polyol A | Polyol B | poured into | density | Content A | Content B | | | | | |
| Foam roller | Type | parts | parts | parts | cavity (g) | (g/cm³) | (mol/g) | (mol/g) | A/B | SA | SB | SA/SB | MA |
| Foam roller 1 | I-1 | 5.0 | 60 | 40 | 2.4 | 0.24 | 0.4 × 10⁻⁶ | 40.5 × 10⁻⁶ | 0.0099 | 50 | 50 | 1.0 | 1.8 |
| Foam roller 2 | I-1 | 3.0 | 60 | 40 | 1.2 | 0.12 | 0.3 × 10⁻⁶ | 23.5 × 10⁻⁶ | 0.0128 | 47 | 53 | 0.9 | 1.8 |
| Foam roller 3 | I-2 | 5.0 | 60 | 40 | 1.3 | 0.13 | 0.3 × 10⁻⁶ | 39.3 × 10⁻⁶ | 0.0076 | 47 | 53 | 0.9 | 1.7 |
| Foam roller 4 | I-2 | 3.0 | 80 | 20 | 0.9 | 0.09 | 0.1 × 10⁻⁶ | 22.5 × 10⁻⁶ | 0.0044 | 44 | 56 | 0.8 | 1.9 |
| Foam roller 5 | I-3 | 3.0 | 80 | 20 | 2.1 | 0.21 | 0.1 × 10⁻⁶ | 24.0 × 10⁻⁶ | 0.0042 | 55 | 45 | 1.2 | 1.7 |
| Foam roller 6 | I-3 | 1.0 | 80 | 20 | 2.0 | 0.20 | 0.06 × 10⁻⁶ | 7.8 × 10⁻⁶ | 0.0077 | 52 | 48 | 1.1 | 1.8 |
| Foam roller 7 | I-3 | 0.5 | 80 | 20 | 2.2 | 0.22 | 0.05 × 10⁻⁶ | 3.9 × 10⁻⁶ | 0.0128 | 50 | 50 | 1.0 | 1.8 |
| Foam roller 8 | I-4 | 3.0 | 80 | 20 | 0.7 | 0.07 | 0.1 × 10⁻⁶ | 23.3 × 10⁻⁶ | 0.0043 | 47 | 53 | 0.9 | 1.7 |
| Foam roller 9 | I-5 | 3.0 | 80 | 20 | 1.3 | 0.13 | 0.1 × 10⁻⁶ | 23.6 × 10⁻⁶ | 0.0042 | 47 | 53 | 0.9 | 1.8 |
| Foam roller 10 | I-6 | 3.0 | 100 | 0 | 0.5 | 0.05 | 0.1 × 10⁻⁶ | 24.3 × 10⁻⁶ | 0.0041 | 44 | 56 | 0.8 | 1.9 |
| Foam roller 11 | I-7 | 3.0 | 0 | 100 | 0.6 | 0.06 | 0.1 × 10⁻⁶ | 24.2 × 10⁻⁶ | 0.0041 | 44 | 56 | 0.8 | 1.8 |
| Foam roller 12 | I-7 | 3.0 | 0 | 100 | 0.6 | 0.06 | 0.1 × 10⁻⁶ | 24.2 × 10⁻⁶ | 0.0041 | 41 | 59 | 0.7 | 1.8 |
| Foam roller 13 | I-7 | 3.0 | 0 | 100 | 0.6 | 0.06 | 0.1 × 10⁻⁶ | 24.2 × 10⁻⁶ | 0.0041 | 44 | 56 | 0.8 | 1.1 |
| Foam roller 14 | I-7 | 3.0 | 0 | 100 | 0.6 | 0.06 | 0.1 × 10⁻⁶ | 24.2 × 10⁻⁶ | 0.0041 | 41 | 59 | 0.7 | 1.1 |
| Comparative | I-8 | 3.0 | 100 | 0 | 2.2 | 0.22 | 0.1 × 10⁻⁶ | 15.0 × 10⁻⁶ | 0.0067 | 33 | 67 | 0.5 | 1.6 |
| Foam roller 1 | | | | | | | | | | | | | |
| Comparative | I-8 | 1.0 | 100 | 0 | 2.0 | 0.20 | 0.1 × 10⁻⁶ | 2.4 × 10⁻⁶ | 0.0417 | 23 | 77 | 0.3 | 1.0 |
| Foam roller 2 | | | | | | | | | | | | | |
| Comparative | I-9 | 3.0 | 0 | 100 | 0.6 | 0.06 | 5.0 × 10⁻⁶ | 23.3 × 10⁻⁶ | 0.2146 | 9 | 91 | 0.1 | 1.6 |
| Foam roller 3 | | | | | | | | | | | | | |
| Comparative | I-10 | 3.0 | 100 | 0 | 1.1 | 0.11 | 7.3 × 10⁻⁶ | 23.4 × 10⁻⁶ | 0.3120 | 9 | 91 | 0.1 | 1.1 |
| Foam roller 4 | | | | | | | | | | | | | |
| Comparative | I-11 | 3.0 | 100 | 0 | 2.2 | 0.22 | 0.1 × 10⁻⁶ | 15.0 × 10⁻⁶ | 0.0067 | 23 | 77 | 0.3 | 1.6 |
| Foam roller 5 | | | | | | | | | | | | | |
| Comparative | I-12 | 3.0 | 100 | 0 | 2.2 | 0.22 | 0.1 × 10⁻⁶ | 15.0 × 10⁻⁶ | 0.0067 | 23 | 77 | 0.3 | 1.6 |
| Foam roller 6 | | | | | | | | | | | | | |

In the table, “parts” indicates a number of blending parts. “Content A (mol/g)” indicates a sum of a content of alkali metal and a content of alkaline-earth metal in the foam layer, and “Content B (mol/g)” indicates a sum of a content of the anion in the foam layer. “SA/SB” indicates the ratio of the area (SA) of the peak detected earlier with respect to the area (SB) of the peak detected later out of the two peaks corresponding to the TDI structure detected by gas chromatography mass spectrometry.

“MA” indicates the ratio of the amount of saturated hydrocarbon component present on the surface of the foam layer with respect to the amount of saturated hydrocarbon component present inside the foam layer.

### Example 1

### Image Evaluation

A method for evaluating images will be described below.

A modified machine of LBP-7600C (manufactured by Canon Inc.), which was a commercially available laser printer, was used as an electrophotographic image forming apparatus. As a modification point, the number of output sheets per unit time was set to 50 sheets/minute for A4-size paper in order to perform evaluation in a high-speed process. As a process cartridge, a commercially available developer cartridge 318 (black) (manufactured by Canon Inc.) was used, and the toner supply roller was replaced with the foam roller 1. At this time, the filling amount of the developer was adjusted to 100 g. Note that yellow, cyan, and magenta cartridges were respectively inserted into the yellow, cyan, and magenta stations, with product toners removed therefrom and with a remaining toner amount detection mechanism disabled, and the evaluation was then conducted.

The prepared process cartridge was mounted on the main body of the electrophotographic image forming apparatus and was left to stand for 24 hours in an environment at a temperature of 0° C. and a relative humidity of 10%. In the same environment, an image in which a printing rate of an alphabet letter “E” with a size of 4 points was 2% with respect to the area of the A4-size paper was successively output on the A4 evaluation paper (GF-C081, manufactured by Canon Inc.). This process was repeated up to 5000 sheets.

After the printing on the 5000 sheets, the system was subsequently left to stand in an environment at a temperature of 0° C. and a humidity of 10% for 120 hours. After the system was left for 120 hours, 10 black solid images were successively output without any pre-rotation operation.

Density unevenness at toner supply roller cycles was visually checked in the output first sheet, fifth sheet, and tenth sheet. Evaluation criteria for evaluating the density unevenness were as follows.

### Evaluation Criteria

Rank A: There were no problems in density unevenness and density differences, and image quality was satisfactory.

Rank B: Although slight density unevenness and density differences were observed, they did not cause problems in utilization.

Rank C: Density unevenness and density differences were observed, which caused disadvantages.

In a case where the content of alkali metal ion and alkaline-earth metal ion with respect to the amount of anion in the foam layer was high, or in a case where the cationic structure and the anion are structures that are unlikely to form an ion aggregate, deformation restorability in a low-temperature low-humidity environment becomes poor, the toner supply performance of the abutting portion is likely to be degraded, and density unevenness is likely to occur. Furthermore, even in a case where the amount of wax component mainly containing the low-molecular-weight saturated hydrocarbon on the surface of the foam roller is small, smoothness of the flat portion on the surface of the foam roller is degraded, adhesiveness to the developing roller is likely to be degraded, and density unevenness is likely to occur.

The evaluation results of the foam roller are shown in Table 3.

TABLE 3

| | | Foam layer | | | Image evaluation | | |
|---|---|---|---|---|---|---|---|
| Example | Foam roller | A/B | SA/SB | MA | First sheet | Fifth sheet | Tenth sheet |
| Example 1 | Foam roller 1 | 0.0099 | 1.0 | 1.8 | A | A | A |
| Example 2 | Foam roller 2 | 0.0128 | 0.9 | 1.8 | A | A | A |
| Example 3 | Foam roller 3 | 0.0076 | 0.9 | 1.7 | A | A | A |
| Example 4 | Foam roller 4 | 0.0044 | 0.8 | 1.9 | A | A | A |
| Example 5 | Foam roller 5 | 0.0042 | 1.2 | 1.7 | A | A | A |
| Example 6 | Foam roller 6 | 0.0077 | 1.1 | 1.8 | A | A | A |
| Example 7 | Foam roller 7 | 0.0128 | 1.0 | 1.8 | A | A | A |
| Example 8 | Foam roller 8 | 0.0043 | 0.9 | 1.7 | B | A | A |
| Example 9 | Foam roller 9 | 0.0042 | 0.9 | 1.8 | B | A | A |
| Example 10 | Foam roller 10 | 0.0041 | 0.8 | 1.9 | B | A | A |
| Example 11 | Foam roller 11 | 0.0041 | 0.8 | 1.8 | B | A | A |
| Example 12 | Foam roller 10 | 0.0041 | 0.7 | 1.8 | B | B | A |
| Example 13 | Foam roller 11 | 0.0041 | 0.8 | 1.1 | B | B | A |
| Example 14 | Foam roller 10 | 0.0041 | 0.7 | 1.1 | B | B | A |
| Comparative | Comparative | 0.0067 | 0.5 | 1.6 | C | C | C |
| Example 1 | Foam roller 1 | | | | | | |
| Comparative | Comparative | 0.0417 | 0.3 | 1.0 | C | C | C |
| Example 2 | Foam roller 2 | | | | | | |
| Comparative | Comparative | 0.2146 | 0.1 | 1.6 | C | C | C |
| Example 3 | Foam roller 3 | | | | | | |
| Comparative | Comparative | 0.3120 | 0.1 | 1.1 | C | C | C |
| Example 4 | Foam roller 4 | | | | | | |
| Comparative | Comparative | 0.0067 | 0.3 | 1.6 | C | C | C |
| Example 5 | Foam roller 5 | | | | | | |
| Comparative | Comparative | 0.0067 | 0.3 | 1.6 | C | C | C |
| Example 6 | Foam roller 6 | | | | | | |

### Examples 2 to 14 and Comparative Examples 1 to 6

In Examples 2 to 14 and Comparative Examples 1 to 6, measurement and evaluation were conducted similarly to those in Example 1 other than that the types of foam rollers were changed as shown in Table 3. The evaluation results are shown in Table 3.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070418, filed Apr. 22, 2025, which is hereby incorporated by reference herein in its entirety.

What is claimed is:

1. A foam roller comprising:
a conductive substrate; and a foam layer on the substrate, wherein
the foam layer comprises polyurethane comprising a urethane bond and an anion,
the polyurethane comprises at least one selected from the group consisting of a cationic structure represented by Structural Formula (1) below, a cationic structure represented by Structural Formula (2) below, a cationic structure represented by Structural Formula (3) below, a cationic structure represented by Structural Formula (4) below, a cationic structure represented by Structural Formula (5) below, and a cationic structure represented by Structural Formula (6) below,
the anion comprises a bis(fluorosulfonyl)imide anion,
an apparent density of the foam layer is 0.03 to 0.25 g/cm³, and
when a sum of a content of alkali metal and a content of alkaline-earth metal in the foam layer extracted by immersing the foam layer in acetone is defined as A (mol/g), and a sum of a content of the anion in the foam layer extracted by immersing the foam layer in acetone is defined as B (mol/g), A/B is 0.0400 or less: 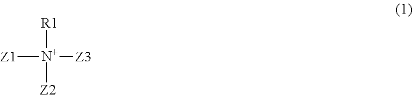
where in Structural Formula (1), R1 represents a hydrocarbon group having 1 to 4 carbon atoms. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, two of Z1 to Z3 are the structure represented by Structural Formula (Z101) below, the structure represented by Structural Formula (Z102) below, or the structure represented by Structural Formula (Z103) below: 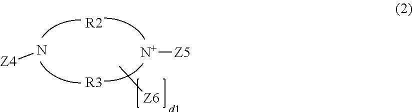
where in Structural Formula (2), R2 and R3 represent a hydrocarbon group needed to form a nitrogen-containing heteroaromatic 5-membered ring together with a nitrogen atom to which each of R2 and R3 is bonded, and d1 represents an integer which is 0 or 1. Z4 to Z6 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z4 to Z6 are the structure represented by Structural Formula (Z101) below, the structure represented by Structural Formula (Z102) below, or the structure represented by Structural Formula (Z103) below: 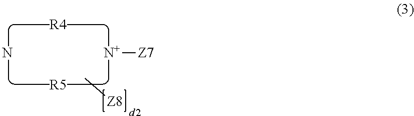
where in Structural Formula (3), R4 and R5 represent a hydrocarbon group needed to form a nitrogen-containing heteroaromatic 6-membered ring together with a nitrogen atom to which each of R4 and R5 is bonded, and d2 represents an integer which is 1 or 2. Z7 and Z8 each independently represent the structure represented by Structural Formula (Z101) below, the structure represented by Structural Formula (Z102) below, the structure represented by Structural Formula (Z103), a hydrogen atom, or a hydrocarbon group having 1 to 4 carbon atoms. However, when d2 is 1, Z7 and Z8 are the structure represented by Structural Formula (Z101) below, the structure represented by Structural Formula (Z102) below, or the structure represented by Structural Formula (Z103) below. When d2 is 2, Z7 and one of Z8 are the structure represented by Structural Formula (Z101), the structure represented by Structural Formula (Z102) below, or the structure represented by Structural Formula (Z103) below, and the other Z8 is a hydrogen atom or a hydrocarbon group having 1 to 4 carbon atoms: 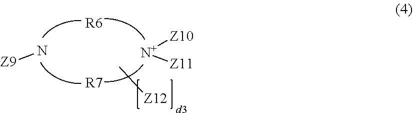
where in Structural Formula (4), R6 and R7 represent a hydrocarbon group needed to form a nitrogen-containing heteroalicyclic group together with a nitrogen atom to which each of R6 and R7 is bonded, and d3 represents an integer which is 0 to 2. Z9 to Z12 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z9 to Z12 are the structure represented by Structural Formula (Z101) below, the structure represented by Structural Formula (Z102) below, or the structure represented by Structural Formula (Z103) below: 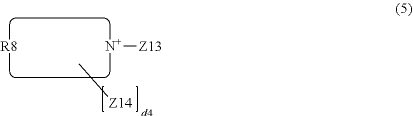
where in Structural Formula (5), R8 represents a hydrocarbon group needed to form a nitrogen-containing aromatic ring together with a nitrogen atom to which R8 is bonded, and d4 represents an integer which is 1 or 2. Z13 and Z14 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms: 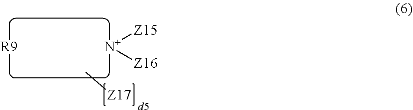
where in Structural Formula (6), R9 represents a hydrocarbon group needed to form a nitrogen-containing heteroalicyclic group together with a nitrogen atom to which R9 is bonded, d5 represents an integer which is 0 or 1, and Z15 to Z17 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z15 to Z17 are the structure represented by Structural Formula (Z101) below, the structure represented by Structural Formula (Z102) below, or the structure represented by Structural Formula (Z103) below: 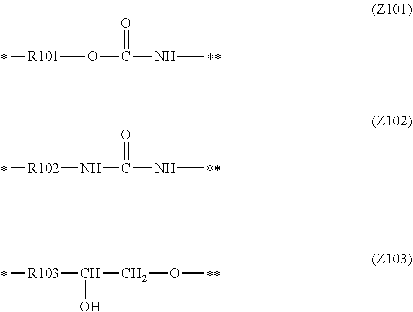
where in Structural Formulas (Z101), (Z102), and (Z103), R101, R102, and R103 each independently represent a linear or branched divalent hydrocarbon group. The symbol “*” represents a bonding portion with a nitrogen atom in Structural Formula (1) or represents a bonding portion with a nitrogen atom or a carbon atom in the nitrogen-containing heterocyclic ring in Structural Formulas (2) to (6). The symbol “**” represents a bonding portion with a carbon atom in a polymer chain of the polyurethane.

2. The foam roller according to claim 1, wherein
the polyurethane comprises at least one tolylene diisocyanate structure selected from the group consisting of a structure represented by Structural Formula (11) below and a structure represented by Structural Formula (12) below: 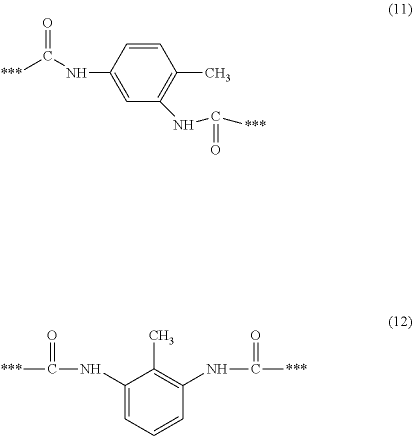
where in Structural Formulas (11) and (12), a symbol “**” represents a bonding portion with a nitrogen atom in the Structural Formula (1), a bonding portion with a nitrogen atom or a carbon atom in a nitrogen-containing heterocyclic ring in the Structural Formulas (2) to (6), or a bonding portion with a carbon atom in a polymer chain in the polyurethane.

3. The foam roller according to claim 2, wherein
when in analysis of the foam layer by a direct sample inlet method using a gas chromatograph mass spectrometer,
a component obtained by raising a temperature up to 1000° C. at a temperature rising speed of 8° C./s and decomposing the foam layer is measured, and a chromatogram is depicted by plotting a detection time on a horizontal axis and plotting detection intensity on a vertical axis,
two peaks corresponding to the tolylene diisocyanate structure are present in the chromatogram, and
when a peak detected earlier out of the two peaks is defined as a peak A, a peak detected later is defined as a peak B, an area of the peak A is defined as SA, and an area of the peak B is defined as SB, the SA and the SB satisfy 0.7≤SA/SB≤1.2.

4. The foam roller according to claim 1, wherein
a wax component mainly comprising a low-molecular-weight saturated hydrocarbon is comprised on a surface of the foam layer.

5. The foam roller according to claim 1, wherein
the cationic structure is a structure represented by Structural Formula (7) below: 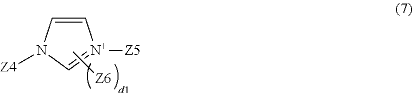
where in Structural Formula (7) below, d1 represents an integer which is 0 or 1. Z4 to Z6 each independently represent the structure represented by Structural Formula (Z101) above, the structure represented by Structural Formula (Z102) above, or the structure represented by Structural Formula (Z103) above. However, two of Z4 to Z6 are the structure represented by Structural Formula (Z101) above, the structure represented by Structural Formula (Z102) above, or the structure represented by Structural Formula (Z103) above.

6. The foam roller according to claim 1, which is a developer supply roller that supplies a developer to a developing roller.

7. A developing device comprising at least:
a developing roller and a developer supply roller that supplies a developer to the developing roller, wherein
the developing device is configured such that a voltage is applicable between the developing roller and the developer supply roller,
the developer supply roller is a foam roller that comprises a conductive substrate and a foam layer on the substrate,
the foam layer comprises polyurethane comprising a urethane bond and an anion,
the polyurethane comprises at least one selected from the group consisting of a cationic structure represented by Structural Formula (1) below, a cationic structure represented by Structural Formula (2) below, a cationic structure represented by Structural Formula (3) below, a cationic structure represented by Structural Formula (4) below, a cationic structure represented by Structural Formula (5) below, and a cationic structure represented by Structural Formula (6) below,
the anion comprises a bis(fluorosulfonyl)imide anion,
an apparent density of the foam layer is 0.03 to 0.25 g/cm³, and
when a sum of a content of alkali metal and a content of alkaline-earth metal in the foam layer extracted by immersing the foam layer in acetone is defined as A (mol/g), and a sum of a content of anion in the foam layer extracted by immersing the foam layer in acetone is defined as B (mol/g), A/B is 0.0400 or less: 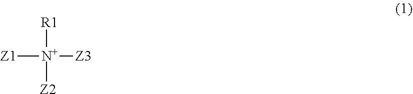
where in Structural Formula (1), R1 represents a hydrocarbon group having 1 to 4 carbon atoms. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, two of Z1 to Z3 are the structure represented by Structural Formula (Z101) below, the structure represented by Structural Formula (Z102) below, or the structure represented by Structural Formula (Z103) below: 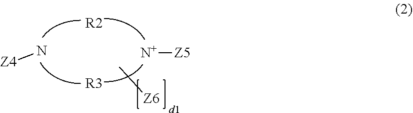
where in Structural Formula (2), R2 and R3 represent a hydrocarbon group needed to form a nitrogen-containing heteroaromatic 5-membered ring together with a nitrogen atom to which each of R2 and R3 is bonded, and d1 represents an integer which is 0 or 1. Z4 to Z6 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z4 to Z6 are the structure represented by Structural Formula (Z101) below, the structure represented by Structural Formula (Z102) below, or the structure represented by Structural Formula (Z103) below: 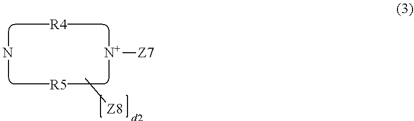
where in Structural Formula (3), R4 and R5 represent a hydrocarbon group needed to form a nitrogen-containing heteroaromatic 6-membered ring together with a nitrogen atom to which each of R4 and R5 is bonded, and d2 represents an integer which is 1 or 2. Z7 and Z8 each independently represent the structure represented by Structural Formula (Z101) below, the structure represented by Structural Formula (Z102) below, the structure represented by Structural Formula (Z103), a hydrogen atom, or a hydrocarbon group having 1 to 4 carbon atoms. However, when d2 is 1, Z7 and Z8 are the structure represented by Structural Formula (Z101) below, the structure represented by Structural Formula (Z102) below, or the structure represented by Structural Formula (Z103) below. When d2 is 2, Z7 and one of Z8 are the structure represented by Structural Formula (Z101), the structure represented by Structural Formula (Z102) below, or the structure represented by Structural Formula (Z103) below, and the other Z8 is a hydrogen atom or a hydrocarbon group having 1 to 4 carbon atoms: 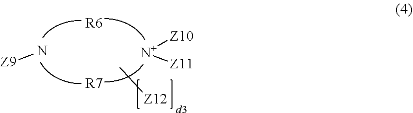
where in Structural Formula (4), R6 and R7 represent a hydrocarbon group needed to form a nitrogen-containing heteroalicyclic group together with a nitrogen atom to which each of R6 and R7 is bonded, and d3 represents an integer which is 0 to 2. Z9 to Z12 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z9 to Z12 are the structure represented by Structural Formula (Z101) below, the structure represented by Structural Formula (Z102) below, or the structure represented by Structural Formula (Z103) below: 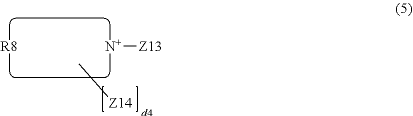
where in Structural Formula (5), R8 represents a hydrocarbon group needed to form a nitrogen-containing aromatic ring together with a nitrogen atom to which R8 is bonded, and d4 represents an integer which is 1 or 2. Z13 and Z14 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms: 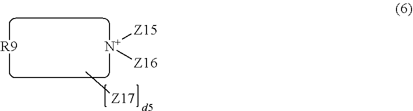
where in Structural Formula (6), R9 represents a hydrocarbon group needed to form a nitrogen-containing heteroalicyclic group together with a nitrogen atom to which R9 is bonded, d5 represents an integer which is 0 or 1, and Z15 to Z17 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z15 to Z17 are the structure represented by Structural Formula (Z101) below, the structure represented by Structural Formula (Z102) below, or the structure represented by Structural Formula (Z103) below: 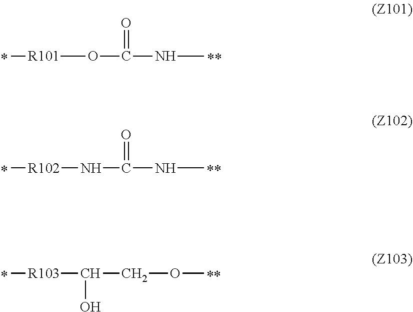
where in Structural Formulas (Z101), (Z102), and (Z103), R101, R102, and R103 each independently represent a linear or branched divalent hydrocarbon group. The symbol “*” represents a bonding portion with a nitrogen atom in Structural Formula (1) or represents a bonding portion with a nitrogen atom or a carbon atom in the nitrogen-containing heterocyclic ring in Structural Formulas (2) to (6). The symbol “**” represents a bonding portion with a carbon atom in a polymer chain of the polyurethane.

8. An electrophotographic image forming apparatus comprising the developing device according to claim 7.

9. A process cartridge that is attachable to and detachable from a main body of an electrophotographic image forming apparatus, the process cartridge comprising:
a contact member that is electrically connected to an electric contact of the main body when the process cartridge is mounted on the main body;
a developing roller; and a developer supply roller that supplies a developer to the developing roller, wherein
the process cartridge is configured such that a voltage is applicable between the developing roller and the developer supply roller through electrical connection to the main body,
the developer supply roller is a foam roller that comprises a conductive substrate and a foam layer on the substrate,
the foam layer comprises polyurethane comprising a urethane bond and an anion,
the polyurethane comprises at least one selected from the group consisting of a cationic structure represented by Structural Formula (1) below, a cationic structure represented by Structural Formula (2) below, a cationic structure represented by Structural Formula (3) below, a cationic structure represented by Structural Formula (4) below, a cationic structure represented by Structural Formula (5) below, and a cationic structure represented by Structural Formula (6) below,
the anion comprises a bis(fluorosulfonyl)imide anion,
an apparent density of the foam layer is 0.03 to 0.25, and
when a sum of a content of alkali metal and a content of alkaline-earth metal in the foam layer extracted by immersing the foam layer in acetone is defined as A (mol/g), and a sum of a content of anion in the foam layer extracted by immersing the foam layer in acetone is defined as B (mol/g), A/B is 0.0400 or less: 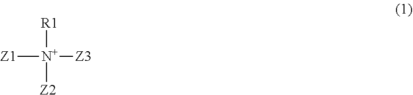
where in Structural Formula (1), R1 represents a hydrocarbon group having 1 to 4 carbon atoms. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, two of Z1 to Z3 are the structure represented by Structural Formula (Z101) below, the structure represented by Structural Formula (Z102) below, or the structure represented by Structural Formula (Z103) below: 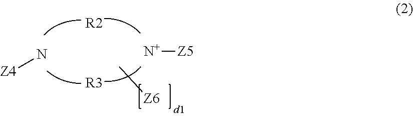
where in Structural Formula (2), R2 and R3 represent a hydrocarbon group needed to form a nitrogen-containing heteroaromatic 5-membered ring together with a nitrogen atom to which each of R2 and R3 is bonded, and d1 represents an integer which is 0 or 1. Z4 to Z6 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z4 to Z6 are the structure represented by Structural Formula (Z101) below, the structure represented by Structural Formula (Z102) below, or the structure represented by Structural Formula (Z103) below: 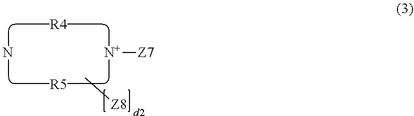
where in Structural Formula (3), R4 and R5 represent a hydrocarbon group needed to form a nitrogen-containing heteroaromatic 6-membered ring together with a nitrogen atom to which each of R4 and R5 is bonded, and d2 represents an integer which is 1 or 2. Z7 and Z8 each independently represent the structure represented by Structural Formula (Z101) below, the structure represented by Structural Formula (Z102) below, the structure represented by Structural Formula (Z103), a hydrogen atom, or a hydrocarbon group having 1 to 4 carbon atoms. However, when d2 is 1, Z7 and Z8 are the structure represented by Structural Formula (Z101) below, the structure represented by Structural Formula (Z102) below, or the structure represented by Structural Formula (Z103) below. When d2 is 2, Z7 and one of Z8 are the structure represented by Structural Formula (Z101), the structure represented by Structural Formula (Z102) below, or the structure represented by Structural Formula (Z103) below, and the other Z8 is a hydrogen atom or a hydrocarbon group having 1 to 4 carbon atoms: 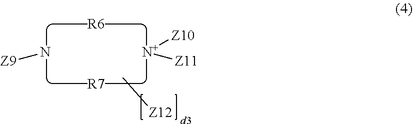
where in Structural Formula (4), R6 and R7 represent a hydrocarbon group needed to form a nitrogen-containing heteroalicyclic group together with a nitrogen atom to which each of R6 and R7 is bonded, and d3 represents an integer which is 0 to 2. Z9 to Z12 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z9 to Z12 are the structure represented by Structural Formula (Z101) below, the structure represented by Structural Formula (Z102) below, or the structure represented by Structural Formula (Z103) below: 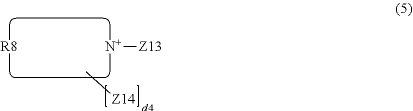
where in Structural Formula (5), R8 represents a hydrocarbon group needed to form a nitrogen-containing aromatic ring together with a nitrogen atom to which R8 is bonded, and d4 represents an integer which is 1 or 2. Z13 and Z14 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, when d4 is 1, Z13 and Z14 are the structure represented by Structural Formula (Z101) below, the structure represented by Structural Formula (Z102) below, or the structure represented by Structural Formula (Z103) below, and when d4 is 2, Z13 and one of Z14 are the structure represented by Structural Formula (Z101) below, the structure represented by Structural Formula (Z102) below, or the structure represented by Structural Formula (Z103) below, and the other Z14 is a hydrogen atom or a hydrocarbon group having 1 to 4 carbon atoms: 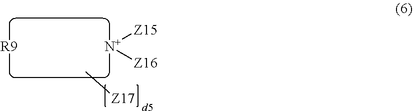
where in Structural Formula (6), R9 represents a hydrocarbon group needed to form a nitrogen-containing heteroalicyclic group together with a nitrogen atom to which R9 is bonded, d5 represents an integer which is 0 or 1, and Z15 to Z17 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, two of Z15 to Z17 are the structure represented by Structural Formula (Z101) below, the structure represented by Structural Formula (Z102) below, or the structure represented by Structural Formula (Z103) below: 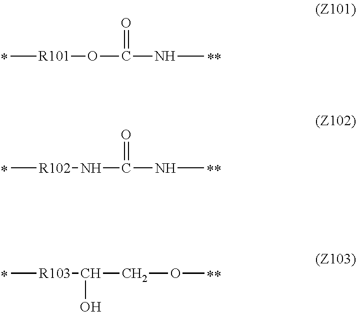
where in Structural Formulas (Z101), (Z102), and (Z103), R101, R102, and R103 each independently represent a linear or branched divalent hydrocarbon group. The symbol “*” represents a bonding portion with a nitrogen atom in Structural Formula (1) or represents a bonding portion with a nitrogen atom or a carbon atom in the nitrogen-containing heterocyclic ring in Structural Formulas (2) to (6). The symbol “**” represents a bonding portion with a carbon atom in a polymer chain of the polyurethane.
